(19) United States
(12) Patent Application Publication
(10) Pub. No.: US 2025/0280211 A1
(43) Pub. Date: Sep. 4, 2025

(54) IMAGING DEVICE

(71) Applicant: Panasonic Intellectual Property Management Co., Ltd., Osaka (JP)

(72) Inventors: TSUTOMU KOBAYASHI, Osaka (JP); MAKOTO SHOUHO, Osaka (JP)

(21) Appl. No.: 19/212,757

(22) Filed: May 20, 2025

Related U.S. Application Data
(63) Continuation of application No. PCT/JP2023/043046, filed on Dec. 1, 2023.

(30) Foreign Application Priority Data
Dec. 15, 2022 (JP) 2022-200408

(51) Int. Cl. H04N 25/772; H04N 25/78

(52) U.S. Cl. CPC H04N 25/772; H04N 25/78

(57) ABSTRACT

An imaging device is provided with: a plurality of pixels, each pixel including a photoelectric converter that converts light into a signal charge and a charge accumulator that accumulates the signal charge, and each pixel outputting a pixel signal VSIG corresponding to an amount of the signal charge accumulated in the charge accumulator; a first conversion circuit that converts the pixel signal VSIG into a first digital signal; and a second conversion circuit that converts the pixel signal VSIG into a second digital signal with a lower resolution than the first digital signal. The imaging device generates first image data containing the first digital signal and second image data containing the second digital signal.

### BACKGROUND

### 1. Technical Field

The present disclosure relates to an imaging device.

### 2. Description of the Related Art

Recent years have seen proposals for achieving high dynamic range in imaging devices such as charge-coupled device (CCD) image sensors and complementary MOS (CMOS) image sensors. Additionally, advances in Internet of things (IoT) and artificial intelligence (AI) technologies have led to demand for imaging devices with a smaller area, lower power consumption, and reduced data transfer.

Japanese Unexamined Patent Application Publication No. 2021-103809 discloses a configuration that performs a plurality of analog-to-digital conversions on a single analog signal to generate a plurality of digital signals.

### SUMMARY

It would be useful if image data with a lower resolution than normal image data could be obtained in addition to, or instead of, the normal image data.

In one general aspect, the techniques disclosed here feature an imaging device provided with: a plurality of pixels, each pixel including a photoelectric converter that converts light into a signal charge and a charge accumulator that accumulates the signal charge, and each pixel outputting a signal corresponding to an amount of the signal charge accumulated in the charge accumulator; a first conversion circuit that converts the signal into a first digital signal; and a second conversion circuit that converts the signal into a second digital signal with a lower resolution than the first digital signal, wherein the imaging device generates first image data containing the first digital signal and second image data containing the second digital signal.

According to an aspect of the present disclosure, an imaging device that can obtain image data with a lower resolution is provided.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating one example of the configuration of an imaging device according to embodiment 1;

FIG. 2 is a circuit diagram illustrating the configuration of a pixel, a conversion circuit, and a signal processing circuit according to embodiment 1;

FIG. 3A is a circuit diagram of a comparator according to configuration example 1;

FIG. 3B is a circuit diagram of a comparator according to configuration example 1;

FIG. 3C is a circuit diagram of a comparator according to configuration example 1;

FIG. 3D is a diagram illustrating the relationship between an input signal and an output signal of a comparator according to configuration example 1;

FIG. 4A is a circuit diagram of a comparator according to configuration example 2;

FIG. 4B is a circuit diagram of a comparator according to configuration example 2;

FIG. 4C is a circuit diagram of a comparator according to configuration example 2;

FIG. 4D is a diagram illustrating the relationship between an input signal and an output signal of a comparator according to configuration example 2;

FIG. 5A is a circuit diagram of a comparator according to configuration example 3;

FIG. 5B is a circuit diagram of a comparator according to configuration example 3;

FIG. 5C is a circuit diagram of a comparator according to configuration example 3;

FIG. 5D is a diagram illustrating the relationship between an input signal and an output signal of a comparator according to configuration example 3;

FIG. 6 is a diagram illustrating a mode table summarizing differences between operating modes of an imaging device according to embodiment 1;

FIG. 7 is a flowchart of operation example 1 of an imaging device according to embodiment 1;

FIG. 8 is one example of a timing chart of operation example 1 of an imaging device according to embodiment 1;

FIG. 9A is a schematic diagram for explaining a specific example in operation example 1 of an imaging device according to embodiment 1;

FIG. 9B is a schematic diagram for explaining a different specific example in operation example 1 of an imaging device according to embodiment 1;

FIG. 10 is a flowchart of operation example 2 of an imaging device according to embodiment 1;

FIG. 11 is one example of a timing chart of operation example 2 of an imaging device according to embodiment 1;

FIG. 12 is a schematic diagram for explaining a specific example in operation example 2 of an imaging device according to embodiment 1;

FIG. 13 is a flowchart of operation example 3 of an imaging device according to embodiment 1;

FIG. 14 is one example of a timing chart of operation example 3 of an imaging device according to embodiment 1;

FIG. 15 is a schematic diagram for explaining a specific example in operation example 3 of an imaging device according to embodiment 1;

FIG. 16 is a flowchart of operation example 4 of an imaging device according to embodiment 1;

FIG. 17 is one example of a timing chart of operation example 4 of an imaging device according to embodiment 1;

FIG. 18 is a schematic diagram for explaining a specific example in operation example 4 of an imaging device according to embodiment 1; and

FIG. 19 is a block diagram illustrating one example of the configuration of a camera system according to embodiment 2.

### DETAILED DESCRIPTIONS

### Underlying Knowledge Forming Basis of the Present Disclosure

Image data with a lower resolution than normal image data, e.g., image data with a resolution of 1-bit or 2-bit, can be obtained faster and with lower power consumption compared to normal image data by providing a dedicated analog-to-digital (AD) conversion circuit. Also, for example, image data with a low resolution can also be obtained without affecting the generation of normal image data by non-destructively reading out pixel signals and performing AD conversion during an exposure period for generating the normal image data.

Furthermore, image data with a lower resolution can also be used as feedback for obtaining optimal exposure conditions and settings for driving the AD conversion circuit. Moreover, image data with a lower resolution can be used in a variety of conceivable ways, since image information that is different from normal image data can be obtained therefrom.

The inventors of the present application studied specific circuit configurations for obtaining image data with a lower resolution and ways of using obtained image data with a lower resolution, and thereby arrived at the configurations in the present disclosure.

### Overview of Present Disclosure

As an overview of the present disclosure, the following gives examples of an imaging device according to the present disclosure.

An imaging device according to a first aspect of the present disclosure is provided with: a plurality of pixels, each pixel including a photoelectric converter that converts light into a signal charge and a charge accumulator that accumulates the signal charge, and each pixel outputting a signal corresponding to an amount of the signal charge accumulated in the charge accumulator; a first conversion circuit configured to convert the signal into a first digital signal; and a second conversion circuit configured to convert the signal into a second digital signal, a resolution of the second digital signal being less than a resolution of the first digital signal, wherein the imaging device generates first image data containing the first digital signal and second image data containing the second digital signal.

With this arrangement, the second image data with a lower resolution can be obtained in addition to the first image data, which is normal image data. Consequently, for example, the second image data can be used to ascertain an illuminance distribution across the entire plurality of pixels in a short AD conversion time.

As another example, an imaging device according to a second aspect of the present disclosure is the imaging device according to the first aspect, wherein the first conversion circuit converts the signal read out non-destructively into the second digital signal.

As another example, an imaging device according to a third aspect of the present disclosure is the imaging device according to the first aspect, wherein the second conversion circuit includes an inverter circuit.

With this arrangement, the second conversion circuit can, with a simple configuration and a limited area, convert the signal to the second digital signal according to whether or not the output from each pixel exceeds a threshold voltage of the inverter.

As another example, an imaging device according to a fourth aspect of the present disclosure is the imaging device according to the third aspect, wherein the inverter circuit includes an inverter with a variable threshold voltage.

With this arrangement, the threshold voltage to serve as a threshold when converting the signal to the second digital signal can be changed to suit the purpose.

As another example, an imaging device according to a fifth aspect of the present disclosure is the imaging device according to the first aspect, wherein the second conversion circuit includes a differential amplifier.

With this arrangement, the threshold when converting the signal into the second digital signal can be changed by changing a reference signal to be compared with the signal inputted into the differential amplifier.

As another example, an imaging device according to a sixth aspect of the present disclosure is the imaging device according to any one of the first to fifth aspects, wherein the first conversion circuit and the second conversion circuit include a shared counter.

With this arrangement, an AD conversion result can be outputted by causing the counter to count according to a clock, while also keeping the area of the counter from increasing.

As another example, an imaging device according to a seventh aspect of the present disclosure is the imaging device according to any one of the first to sixth aspects, wherein the first conversion circuit and the second conversion circuit include a shared latch.

With this arrangement, the first digital signal and the second digital signal can be held, while also keeping the area of the latch from increasing.

As another example, an imaging device according to an eighth aspect of the present disclosure is the imaging device according to any one of the first to seventh aspects, wherein the first conversion circuit includes a comparator that compares the signal with a reference signal, and the second conversion circuit does not include a comparator that uses the reference signal.

This arrangement enables the first conversion circuit to change the threshold by using the reference signal, and also makes it possible to save power, since the second conversion circuit does not use the reference signal.

As another example, an imaging device according to a ninth aspect of the present disclosure is the imaging device according to any one of the first to eighth aspects, further provided with a signal processing circuit to which the first image data and the second image data are input.

This allows for more complex image processing and other signal processing.

As another example, an imaging device according to a 10th aspect of the present disclosure is the imaging device according to the ninth aspect, wherein the signal processing circuit includes a frame memory that holds the second image data.

This allows for image processing using a plurality of second image data; for example, a plurality of second image data can be merged and outputted.

For example, an imaging device according to an 11th aspect of the present disclosure is the imaging device according to the ninth or 10th aspect, wherein the imaging device generates a plurality of the second image data under mutually different imaging conditions, and the signal processing circuit outputs a merged image obtained by integrating the plurality of second image data.

This allows for the output of a merged image with gradation data adjusted to a desired resolution.

As another example, an imaging device according to a 12th aspect of the present disclosure is the imaging device according to any one of the first to 11th aspects, wherein the second conversion circuit converts the signal into the second digital signal multiple times in a period, within one frame period, during which the signal is not destroyed.

This allows for the output of a plurality of non-destructive data based on the signal in a short AD conversion time.

As another example, an imaging device according to a 13th aspect of the present disclosure is the imaging device according to any one of the first to 12th aspects, further provided with a control circuit, wherein the control circuit adjusts imaging conditions based on the second image data.

With this arrangement, the imaging conditions can be adjusted using the second image data, which can be generated in a short AD conversion time. Consequently, for example, the imaging device can generate image data according to desired imaging conditions, even under different illuminance conditions.

As another example, an imaging device according to a 14th aspect of the present disclosure is the imaging device according to the 13th aspect, wherein the control circuit determines imaging conditions for generating the first image data in a second period after a first period, based on the second image data containing the second digital signal converted by the second conversion circuit from the signal corresponding to the amount of the signal charge converted by the photoelectric converter in the first period.

With this arrangement, the imaging conditions for generating the first image data can be adjusted using the second image data, which can be generated in a short AD conversion time.

As another example, an imaging device according to a 15th aspect of the present disclosure is the imaging device according to any one of the first to 10th aspects, further provided with a control circuit, wherein the control circuit performs the following in a period, within one frame period, during which the signal is not destroyed: the control circuit repeatedly causes the second conversion circuit to convert the signal into the second digital signal until the second image data meets a prescribed condition; and once the second image data meets the prescribed condition, the control circuit causes the first conversion circuit to convert the signal into the first digital signal.

With this arrangement, the exposure time is adjustable without destroying the signal, and thus the first image data with an adjusted exposure time can be generated rapidly.

As another example, an imaging device according to a 16th aspect of the present disclosure is the imaging device according to any one of the first to 10th aspects, further provided with a control circuit, wherein the control circuit performs the following in a period, within one frame period, during which the signal is not destroyed: the control circuit repeatedly causes the second conversion circuit to convert the signal into the second digital signal until the second image data meets a prescribed condition; and the control circuit outputs the second image data that meets the prescribed condition.

This allows for rapid output of the second image data with a desired exposure time.

As another example, an imaging device according to a 17th aspect of the present disclosure is the imaging device according to any one of the first to 16th aspects, wherein the resolution of the second digital signal is 4 or less.

With this arrangement, the second image data can be generated rapidly.

As another example, an imaging device according to an 18th aspect of the present disclosure is the imaging device according to the 17th aspect, wherein the resolution of the second digital signal is 2.

With this arrangement, the second image data can be generated more rapidly.

As another example, an imaging device according to a 19th aspect of the present disclosure is the imaging device according to any one of the first to 18th aspects, further provided with a signal line to which the signal is input, wherein the first conversion circuit and the second conversion circuit are connected to the signal line in parallel.

With this arrangement, the first conversion circuit and the second conversion circuit can be made to operate on the signal generated in the same exposure period, which allows for a reduction in the AD conversion time.

An imaging device according to a 20th aspect of the present disclosure is provided with: a plurality of pixels, each pixel including a photoelectric converter that converts light into a signal charge, and each pixel outputting a signal corresponding to an amount of the signal charges; and a conversion circuit configured to convert the signal into a digital signal, a resolution of the digital signal being 2, wherein the imaging device generates image data containing the digital signal.

With this arrangement, image data with a lower resolution can be generated and obtained rapidly. Consequently, for example, the image data can be used to ascertain an illuminance distribution across the entire plurality of pixels in a short AD conversion time.

Hereinafter, embodiments will be described in detail and with reference to the drawings. Note that the embodiments described hereinafter all illustrate general or specific examples. Features such as numerical values, shapes, materials, structural elements, arrangements and connection states of structural elements, steps, and the ordering of steps indicated in the following embodiments are merely examples, and are not intended to limit the present disclosure. The various aspects described in this specification may also be combined with each other in non-contradictory ways. In addition, among the structural elements in the following embodiments, structural elements that are not described in the independent claims are described as arbitrary or optional structural elements. In the following description, structural elements having substantially the same functions will be denoted by common reference signs, and the description of such structural elements may be reduced or omitted. Also, each diagram is a schematic diagram, and does not necessarily illustrate a strict representation. Also, to keep the drawings from being overly complex, some elements may be omitted from illustration.

### Embodiment 1

Hereinafter, an imaging device according to embodiment 1 will be described.

### Overall Configuration

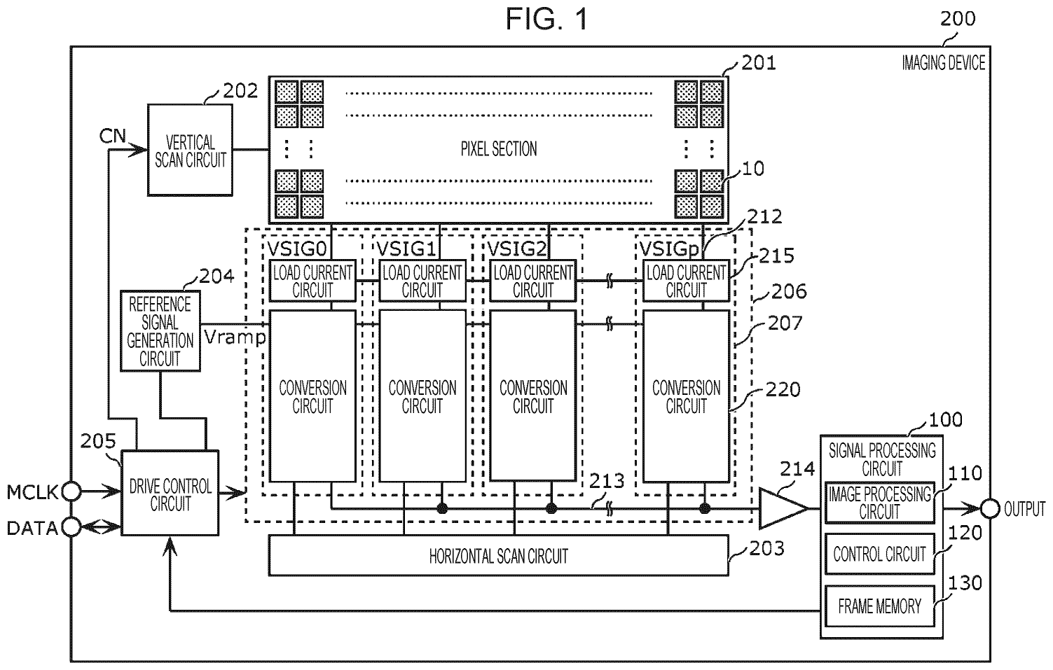

First, FIG. 1 will be used to describe the overall configuration of an imaging device according to the present embodiment. FIG. 1 is a block diagram illustrating one example of the configuration of an imaging device according to the present embodiment. The imaging device 200 according to the present embodiment illustrated in FIG. 1 is a solid-state imaging device, for example, and is a CMOS image sensor, for example. The imaging device 200 is provided with a pixel section 201, a vertical scan circuit 202, a horizontal scan circuit 203, a reference signal generation circuit 204, a drive control circuit 205, a column processing section 206, a plurality of vertical signal lines 212, a horizontal signal line 213, an amplification circuit 214, and a signal processing circuit 100.

The pixel section 201 includes a plurality of pixels 10 arranged in a matrix of rows and columns. The pixels 10 generate signal charges by photoelectric conversion of incident light, and generate electrical signals, namely pixel signals VSIG0 to VSIGp, on the basis of the signal charges. The pixel signals are one example of a signal. Details of the pixels 10 will be described later.

The vertical scan circuit 202 controls row addressing and row scanning.

The vertical signal lines 212 are provided with respect to each column, with each vertical signal line 212 being connected to the pixels arranged in a column among the plurality of pixels 10. The vertical signal lines 212 transmit, to the column processing section 206, the pixel signals VSIG0 to VSIGp outputted from the pixels 10 arranged in the corresponding columns from among column 0 to column p (where p is an integer equal to or greater than 1) of the plurality of pixels 10.

The column processing section 206 includes a plurality of column circuits 207. Image data containing digital signals corresponding to each of the pixels 10 is generated by the column processing section 206. Each column circuit 207 includes a load current circuit 215 and a conversion circuit 220. The column circuits 207 are provided with respect to each column of the plurality of pixels 10. Each column circuit 207 is connected to the vertical signal lines 212 of the corresponding column. When a pixel signal is transmitted to the vertical signal line 212 of a corresponding column, the load current circuit 215 supplies a load current to that vertical signal line 212.

The conversion circuit 220 converts the analog pixel signal transmitted to the vertical signal line 212 of a corresponding column into a digital signal. Details of the conversion circuit 220 will be described later.

The reference signal generation circuit 204 generates a reference signal Vramp and supplies the generated reference signal Vramp to each of the plurality of conversion circuits 220. The reference signal Vramp is one example of a reference signal.

The horizontal scan circuit 203 controls column addressing and column scanning.

The horizontal signal line 213 transmits a plurality of digital signals generated by the column processing section 206. The amplification circuit 214 is connected to the horizontal signal line 213. The digital signals of each of the columns are amplified by the amplification circuit 214 and inputted into the signal processing circuit 100 via the horizontal signal line 213, in order from the digital signal corresponding to the pixels in the column selected by the horizontal scanning circuit 203.

The drive control circuit 205 generates signals for driving each of the circuits inside the imaging device 200. The drive control circuit 205 collectively generates various internal clocks on the basis of a control signal from the signal processing circuit 100, a master clock signal inputted from an MCLK pin, and data signals for various settings inputted from a DATA pin, and supplies the generated internal clocks to each of the circuits inside the imaging device 200. Specifically, the drive control circuit 205 supplies a control signal CN to the vertical scan circuit 202, and the vertical scan circuit 202 operates according to the control signal CN. The drive control circuit 205 also supplies control signals for controlling switches or the like in the conversion circuits 220. The drive control circuit 205 may also be included in the control circuit 120.

The signal processing circuit 100 includes an image processing circuit 110, a control circuit 120, and a frame memory 130. The signal processing circuit 100 performs parallel-to-serial conversion and the like on inputted digital signals, for example, and outputs the result to the outside of the imaging device 200. Details of the signal processing circuit 100 will be described later.

### Configuration of Pixel, Conversion Circuit, and Signal Processing Circuit

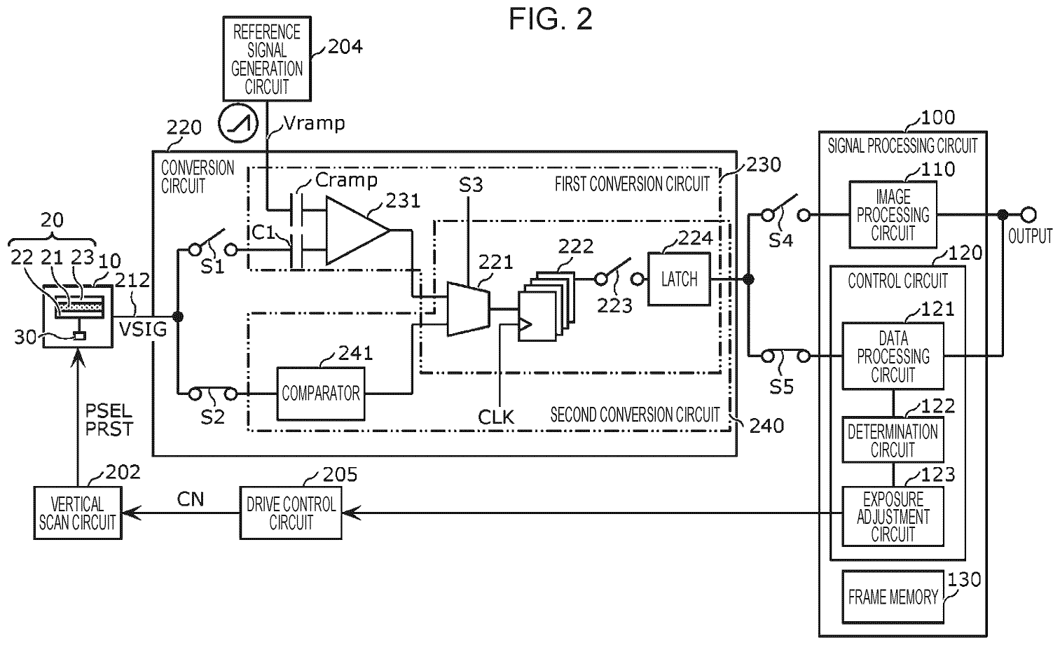

Next, a detailed configuration of the pixel 10, the conversion circuit 220, and the signal processing circuit 100 of the imaging device 200 will be described. FIG. 2 is a circuit diagram illustrating the configuration of a pixel, a conversion circuit, and a signal processing circuit according to the present embodiment. Note that in FIG. 2, a portion of the configuration illustrated in FIG. 1 is omitted from illustration.

First, the pixel 10 will be described. As illustrated in FIG. 2, a pixel signal VSIG outputted from the pixel 10 is transmitted to the conversion circuit 220 via the vertical signal line 212. Each pixel 10 of the pixel section 201 includes, for example, a photoelectric converter 20 that converts light into signal charges and a charge accumulator 30 that accumulates signal charges converted by the photoelectric converter 20. The potential of the charge accumulator 30 fluctuates according to the amount of signal charges accumulated. The pixel 10 outputs the pixel signal VSIG corresponding to the potential of the charge accumulator 30, for example. The pixel 10 operates on the basis of a pixel select signal PSEL, a pixel reset signal PRST, and the like from the vertical scan circuit 202, for example.

The photoelectric converter 20 is a multilayer photoelectric conversion element including a photoelectric conversion layer 21 that converts light into signal charges, and a pair of electrodes, namely a pixel electrode 22 and a counter electrode 23, which are layered with the photoelectric conversion layer 21 so as to sandwich the photoelectric conversion layer 21. The photoelectric conversion layer 21 receives the incidence of light and generates excitons, such as hole-electron pairs, for example. The pixel electrode 22 collects one out of the generated pairs of holes and electrons as signal charges. For example, a voltage is supplied to the counter electrode 23 such that a potential difference is created between the pixel electrode 22 and the counter electrode 23, and on the basis of the potential difference, one out of the pairs of holes and electrons is collected at the pixel electrode 22. The pixel electrode 22 and the charge accumulator 30 are connected, and signal charges collected at the pixel electrode 22 are accumulated in the charge accumulator 30.

The plurality of pixels 10 in the pixel section 201 may be exposed by global shutter driving or rolling shutter driving.

In the case of global shutter driving, in an exposure period, a voltage for creating a sufficiently large potential difference between the pixel electrode 22 and the counter electrode 23 is supplied to the counter electrode 23. With this arrangement, in each pixel 10, signal charges generated by photoelectric conversion in the photoelectric conversion layer 21 move to the pixel electrode 22 and are accumulated in the charge accumulator 30. After the exposure period ends, a voltage whereby the movement of signal charges substantially does not occur in the photoelectric conversion layer 21, such as a small voltage for bringing the potential difference to or near zero, for example, is supplied to the counter electrode 23. With this arrangement, in each pixel 10, signal charges generated by photoelectric conversion in the photoelectric conversion layer 21 substantially are no longer accumulated in the charge accumulator 30.

Meanwhile, in the case of rolling shutter driving, the same voltage as during exposure is supplied to the counter electrode 23 after exposure, too, and the time from the reset of the pixel 10 to the readout of the pixel signal VSIG is the exposure period.

Also, the plurality of pixels 10 in the pixel section 201 may also be subjected to electronic neutral density (ND) driving and made to function electrically as an ND filter. In electronic ND driving, the potential difference between the pixel electrode 22 and the counter electrode 23 may be changed to adjust the sensitivity of the pixel section 201. For example, in the case of raising the sensitivity of the pixel section 201, the voltage applied to the counter electrode 23 is adjusted so as to increase the potential difference between the pixel electrode 22 and the counter electrode 23, and in the case of lowering the sensitivity of the pixel section 201, the voltage applied to the counter electrode 23 is adjusted so as to decrease the potential difference between the pixel electrode 22 and the counter electrode 23. Alternatively, in electronic ND driving, a periodic pulse voltage may be applied between the pixel electrode 22 and the counter electrode 23 and the duty ratio of the pulse voltage may be changed to adjust the sensitivity of the pixel section 201. For example, in the case of raising the sensitivity of the pixel section 201, the duty ratio of the pulse voltage applied to the counter electrode 23 is increased, and in the case of lowering the sensitivity of the pixel section 201, the duty ratio of the pulse voltage applied to the counter electrode 23 is decreased.

Next, the conversion circuit 220 will be described. The conversion circuit 220 includes a first conversion circuit 230 and a second conversion circuit 240. The first conversion circuit 230 and the second conversion circuit 240 are connected to the vertical signal line 212 in parallel. With this arrangement, the first conversion circuit 230 and the second conversion circuit 240 can be made to operate on the pixel signal VSIG generated in the same exposure period, which allows for a reduction in the AD conversion time.

The first conversion circuit 230 converts the pixel signal VSIG into a first digital signal. The resolution of the first digital signal is 8 bits (256) or more, for example. The first conversion circuit 230 is connected to the vertical signal line 212 via a switch S1, and receives the input of the pixel signal VSIG from the pixel 10 via the switch S1. One end of the switch S1 is connected to the vertical signal line 212, and the other end of the switch S1 is connected to the first conversion circuit 230.

The second conversion circuit 240 converts the pixel signal VSIG into a second digital signal with a lower resolution than the first digital signal. The resolution of the second digital signal is 4 or lower, for example, and may be 2. Since the second digital signal has a lower resolution than the first digital signal, the second conversion circuit 240 can be used to AD-convert the second digital signal faster and with lower power consumption than the AD conversion by the first conversion circuit 230. For example, power can be saved because the reference signal generation circuit 204 need not generate a ramp signal for AD conversion. The following describes an example in which the second digital signal has a resolution of 2. The second conversion circuit 240 is connected to the vertical signal line 212 via a switch S2, and receives the input of the pixel signal VSIG from the pixel 10 via the switch S2. One end of the switch S2 is connected to the vertical signal line 212, and the other end of the switch S2 is connected to the second conversion circuit 240.

The first conversion circuit 230 includes a capacitor C1, a capacitor Cramp, a comparator 231, a selector 221, a counter 222, a switch 223, and a latch 224. The second conversion circuit 240 includes a comparator 241, the selector 221, the counter 222, the switch 223, and the latch 224. The selector 221, the counter 222, the switch 223, and the latch 224 are shared by the first conversion circuit 230 and the second conversion circuit 240. Note that at least one of the counter 222, the switch 223, or the latch 224 may also be provided in each of the first conversion circuit 230 and the second conversion circuit 240, without being shared by the first conversion circuit 230 and the second conversion circuit 240.

One end of the capacitor C1 is connected to the other end of the switch S1, and the other end of the capacitor C1 is connected to the comparator 231. One end of the capacitor Cramp is connected to the reference signal generation circuit 204, and the other end of the capacitor Cramp is connected to the comparator 231.

The comparator 231 compares the pixel signal VSIG of the corresponding column inputted via the switch S1 and the capacitor C1 with a reference signal Vramp inputted via the capacitor Cramp, and outputs a comparison result. The output terminal of the comparator 231 is connected to the selector 221.

The comparator 241 compares the pixel signal VSIG of the corresponding column inputted via the switch S2 with a prescribed threshold, and outputs a comparison result. The second conversion circuit 240 does not include a comparator that uses the reference signal Vramp, and thus can operate at lower power. A detailed configuration of the comparator 241 will be described later.

The selector 221 accepts, as inputs, the output of the comparator 231 and the output of the comparator 241, and selects whether to output the output of the comparator 231 or the output of the comparator 241 to the counter 222 according to a select signal S3. The select signal S3 is outputted from the drive control circuit 205, for example.

The counter 222 counts time on the basis of a counter clock CLK. The counter 222 outputs a count result as a digital signal.

The switch 223 is disposed on the path between the counter 222 and the latch 224. One end of the switch 223 is connected to the output terminal of the counter 222, and the other end of the switch 223 is connected to the latch 224. The digital signal outputted from the counter 222 is stored, via the switch 223, in a latch 224 for each column of the plurality of pixels 10.

The latch 224 temporarily stores a digital signal generated by the conversion circuit 220. The digital signal stored in the latch 224 corresponding to each column of the plurality of pixels 10 is outputted on the basis of control by the horizontal scan circuit 203, which is not illustrated in FIG. 2. The outputting of a digital signal from the latch 224 of each column means that the conversion circuit 220 outputs first image data, which includes the first digital signal converted by the first conversion circuit 230, or second image data, which includes the second digital signal converted by the second conversion circuit 240.

Downstream of the latch 224, a switch S4 and a switch S5 are connected in parallel. The digital signals stored in the latches 224 of each of the columns are outputted sequentially and inputted as image data into the signal processing circuit 100 via the switch S4 or the switch S5. Specifically, one end of the switch S4 is connected to the latch 224, and the other end of the switch S4 is connected to the image processing circuit 110 of the signal processing circuit 100. Meanwhile, one end of the switch S5 is connected to the latch 224, and the other end of the switch S5 is connected to the control circuit 120 (more specifically, a data processing circuit 121) of the signal processing circuit 100.

The switch S1, the switch S2, the switch 223, the switch S4, and the switch S5 are each switched between conducting (ON) and non-conducting (OFF) states by the drive control circuit 205.

Note that in the example illustrated in FIG. 2, the counter 222 is connected downstream of the selector 221, but is not limited thereto. For example, the counter 222 may also be disposed on the path between the comparator 231 and the selector 221. In this case, the output of the comparator 231 is inputted directly into the counter 222 without going through the selector 221, and the selector 221 is configured to select between the output of the counter 222 and the output of the comparator 241. Also, the output of the comparator 241 is inputted into the latch 224 without going through the counter 222. Consequently, in this case, the counter 222 is not shared by the first conversion circuit 230 and the second conversion circuit 240.

Next, the signal processing circuit 100 will be described. As described above, the signal processing circuit 100 includes the image processing circuit 110, the control circuit 120, and the frame memory 130.

First image data is inputted into the image processing circuit 110, for example. The image processing circuit 110 performs conversion processing, correction processing, and the like, as necessary, on the first image data from the conversion circuit 220, and outputs the processed image data to the outside.

The control circuit 120 includes a data processing circuit 121, a determination circuit 122, and an exposure adjustment circuit 123, for example.

Second image data is inputted into the data processing circuit 121, for example. The data processing circuit 121 performs data processing on the second image data. For example, the data processing circuit 121 aggregates the output values (in other words, the pixel values) of all pixels 10 in the second image data. The data processing circuit 121 may also perform conversion processing, correction processing, and the like, as necessary, on the second image data from the conversion circuit 220, and output the processed image data to the outside.

The determination circuit 122 makes a determination using a data processing result from the data processing circuit 121. For example, the determination circuit 122 determines whether or not the second image data meets a prescribed condition, on the basis of a result of the aggregation by the data processing circuit 121.

The exposure adjustment circuit 123 adjusts exposure conditions that serve as imaging conditions of the imaging device 200, on the basis of a result of the data processing by the data processing circuit 121 or a result of the determination by the determination circuit 122. For example, the exposure adjustment circuit 123 decides exposure conditions such as the period from a reset of the pixels to the readout of a pixel signal in the case of rolling shutter driving, the exposure period in the case of global shutter driving, or the voltage value to be applied to the counter electrode 23 in the case of electronic ND driving. The exposure adjustment circuit 123 drives the drive control circuit 205 such that imaging is performed according to the decided exposure conditions. The drive control circuit 205 modifies the driving of each circuit of the imaging device 200 on the basis of the exposure conditions decided by the exposure adjustment circuit 123. The exposure adjustment circuit 123 may also include a table in which the results of data processing by the data processing circuit 121 or the results of determinations by the determination circuit 122 are associated with exposure conditions. The exposure adjustment circuit 123 uses the table to decide the exposure conditions, for example.

Details of the operation of the image processing circuit 110 and the control circuit 120 will be described later. Note that the image processing circuit 110 and the control circuit 120 need not be separated, and the functions of the image processing circuit 110 and the control circuit 120 may also be realized by a processing circuit that accepts both the first image data and the second image data as inputs. In this case, the switch S4 and the switch S5 need not be provided in the imaging device 200.

The frame memory 130 is a memory for holding the second image data inputted from the conversion circuit 220. The frame memory 130 may also hold the first image data inputted from the conversion circuit 220.

The signal processing circuit 100 may be realized by a microcontroller including one or more processors and a memory. The signal processing circuit 100 may also include dedicated logic circuitry for performing the processing described later.

### AD Conversion Operation

Next, the AD conversion operation by the imaging device 200 will be described with reference to FIGS. 1 and 2. The imaging device 200 according to the present embodiment is an image sensor of the column-parallel AD conversion type. When taking a desired image with the imaging device 200, light incident on the imaging device 200 is converted into a pixel signal, that is, an electrical signal, in the pixel section 201.

The plurality of pixels 10 of the pixel section 201 are controlled in units of rows by the vertical scan circuit 202. The pixel signals VSIG0 to VSIGp generated by the pixels 10 belonging to a row selected by the vertical scan circuit 202 are outputted to the plurality of vertical signal lines 212 at the same time. Meanwhile, a load current is supplied to the plurality of vertical signal lines 212 by the plurality of load current circuits 215.

Hereinafter, the operation whereby the conversion circuit 220 AD-converts the pixel signal VSIG will be described with reference to FIG. 2.

First, a case will be described in which the first conversion circuit 230 of the conversion circuit 220 AD-converts the pixel signal VSIG into a first digital signal, and first image data containing the first digital signal is generated.

In the case where the first conversion circuit 230 is to AD-convert the pixel signal VSIG into a first digital signal, the switch S1 is turned on, the switch S2 is turned off, the switch S4 is turned on, and the switch S5 is turned off. Also, the selector 221 selects and outputs the output of the comparator 231 to the counter 222.

The comparator 231 compares the reference signal Vramp outputted by the reference signal generation circuit 204 with the pixel signal VSIG of the corresponding column. The reference signal Vramp used for comparison at this point is, for example, a ramp signal with a sloping voltage value that at least increases monotonically or decreases monotonically. The counter 222 counts the time from when a count period starts at a timing that corresponds to the start timing of the ramp signal to when the larger/smaller relationship between the pixel signal VSIG and the reference signal Vramp is inverted. This converts the pixel signal VSIG, which is an analog signal, into a first digital signal as the count value of the counter 222. That is, the comparator 231 and the counter 222 form a first AD conversion circuit, and the pixel signal VSIG of each column is converted from an analog signal to a first digital signal by the first AD conversion circuit of each column. In this way, the first conversion circuit 230 is an AD converter that converts the pixel signal VSIG of each column generated in the pixel section 201 from an analog signal to a first digital signal in units of the pixels 10.

The first digital signal is stored in the latch 224 of each column via the switch 223, which is switched between conducting and non-conducting states by the drive control circuit 205. The first digital signal stored in the latch 224 of each column is outputted, via the switch S4, to the image processing circuit 110 of the signal processing circuit 100 in order from the column selected in the horizontal scan circuit 203. Also, the columns of the pixel section 201 are sequentially selected to perform this operation. As a result, first image data containing the first digital signal corresponding to each pixel 10 is generated, and the first image data is inputted into the image processing circuit 110.

Next, a case will be described in which the second conversion circuit 240 of the conversion circuit 220 AD-converts the pixel signal VSIG into a second digital signal, and second image data containing the second digital signal is generated.

In the case where the second conversion circuit 240 is to AD-convert the pixel signal VSIG into a second digital signal, the switch S1 is turned off, the switch S2 is turned on, the switch S4 is turned off, and the switch S5 is turned on. Also, the selector 221 selects and outputs the output of the comparator 241 to the counter 222.

The comparator 241 compares a prescribed threshold (the details of which will be described later) with the pixel signal VSIG of the corresponding column. For example, the comparator 241 outputs a voltage that is high or low depending on whether or not the pixel signal VSIG is equal to or greater than the prescribed threshold. When a count period begins, the counter 222 outputs a count value on the basis of whether the output from the comparator 241 is high or low. For example, the counter 222 outputs a count value of 1 when the output of the comparator 241 is high and outputs a count value of 0 when the output of the comparator 241 is low. This converts the pixel signal VSIG, which is an analog signal, into a second digital signal as the count value of the counter 222. That is, the comparator 241 and the counter 222 form a second AD conversion circuit, and the pixel signal VSIG of each column is converted from an analog signal to a second digital signal by the second AD conversion circuit of each column. In this way, the second conversion circuit 240 is an AD converter that converts the pixel signal VSIG of each column generated in the pixel section 201 from an analog signal to a second digital signal in units of the pixels 10. Note that in the case where the output of the comparator 241 is outputted without going through the counter 222, the output itself of the comparator 241 serves as the second digital signal.

The second digital signal is stored in the latch 224 of each column via the switch 223. The second digital signal stored in the latch 224 of each column is outputted, via the switch S5, to the data processing circuit 121 of the signal processing circuit 100 in order from the column selected in the horizontal scan circuit 203. Also, the columns of the pixel section 201 are sequentially selected to perform this operation. As a result, second image data containing the second digital signal corresponding to each pixel 10 is generated, and the second image data is inputted into the data processing circuit 121.

### Configuration Examples of Comparator in Second Conversion Circuit

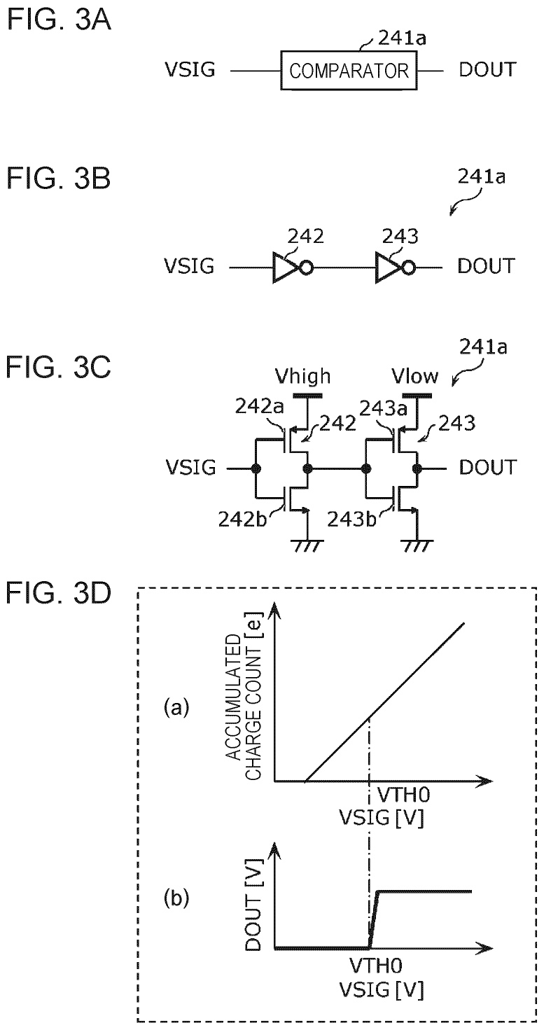

Next, configuration examples of the comparator 241 in the second conversion circuit 240 will be described. For example, a comparator according to one of configuration examples 1 to 3 described below using FIGS. 3A to 5D is used as the comparator 241. Note that the configuration examples of the comparator 241 described below are merely examples, and the configuration is not particularly limited insofar as the configuration can compare the pixel signal VSIG with a prescribed threshold.

### (1) Configuration Example 1

First, a comparator according to configuration example 1 will be described. FIGS. 3A to 3C are circuit diagrams of a comparator according to configuration example 1. A comparator 241a according to configuration example 1 is illustrated as a function block in FIG. 3A, is illustrated at the symbol level in FIG. 3B, and is illustrated at the transistor level in FIG. 3C. As illustrated in FIGS. 3A to 3C, the comparator 241a is a comparator of the inverter type. The comparator 241a is formed from two inverters 242 and 243.

In the comparator 241a, the inverter 242 and the inverter 243 are connected in series. The pixel signal VSIG is inputted into the inverter 242, and the output of the inverter 242 is inputted into the inverter 243. The inverter 243 outputs an output signal DOUT. The inverter 242 includes a P-type metal-oxide-semiconductor (MOS) transistor 242a and an N-type MOS transistor 242b. The inverter 243 includes a P-type metal-oxide-semiconductor (MOS) transistor 243a and an N-type MOS transistor 243b.

FIG. 3D is a diagram illustrating the relationship between the input signal, namely the pixel signal VSIG, and the output signal DOUT of the comparator 241a. In (a) of FIG. 3D, the relationship between the pixel signal VSIG and an accumulated charge count in the charge accumulator 30 is illustrated, and in (b) of FIG. 3D, the relationship between the pixel signal VSIG and the output signal DOUT is illustrated.

As illustrated in (a) of FIG. 3D, when the accumulated charge count in the charge accumulator 30 increases because of signal charges being generated due to the incidence of light and accumulated in the charge accumulator 30, the pixel signal VSIG also increases. Also, as illustrated in (b) of FIG. 3D, the pixel signal VSIG increases, and if the pixel signal VSIG exceeds a threshold voltage VTH0, the output signal DOUT changes from low to high. Thus, the accumulated charge count in the charge accumulator 30 increases gradually, and once the pixel signal VSIG exceeds the threshold voltage VTH0, the output signal DOUT of the comparator 241a changes from low (for example, a digital value of zero) to high (for example, a digital value of 1). That is, the output signal DOUT goes high when the potential of the pixel signal VSIG inputted into the comparator 241a is higher than the threshold voltage VTH0, and conversely, the output signal DOUT goes low when the potential is equal to or lower than the threshold voltage VTH0. The threshold voltage VTH0 is the threshold voltage of the inverter 242, and is determined by the characteristics of the P-type MOS transistor 242a and the N-type MOS transistor 242b. Specifically, the threshold voltage VTH0 is determined by the following expression (1):

$$VTH 0 = \frac{Vhigh - \vert Vtp \vert + Vtn \sqrt{{β}_{n} / {β}_{p}}}{1 + \sqrt{{β}_{n} / {β}_{p}}} \qquad ( 1 )$$

where Vhigh is the voltage applied to the source of the P-type MOS transistor 242a, Vtp is the threshold voltage of the P-type MOS transistor 242a, and Vtn is the threshold voltage of the N-type MOS transistor 242b. Also, βₚ and βₙ are constants defined by the following expressions (2) and (3):

$${β}_{p} = \frac{{W}_{p}}{{L}_{p}} {μ}_{p} {C}_{ox} \qquad ( 2 )$$

$${β}_{n} = \frac{{W}_{n}}{{L}_{n}} {μ}_{n} {C}_{ox} \qquad ( 3 )$$

where Wₚ is the gate width of the P-type MOS transistor 242a, Lₚ is the gate length of the P-type MOS transistor 242a, and μp is the carrier mobility of the P-type MOS transistor 242a. Also, Wₙ is the gate width of the N-type MOS transistor 242b, Lₙ is the gate length of the N-type MOS transistor 242b, and μn is the carrier mobility of the N-type MOS transistor 242b. Also, Cₒₓ is the capacitance per unit volume of the gate oxide film of the P-type MOS transistor 242a and the N-type MOS transistor 242b.

The inverter 243 is designed such that, for example, the P-type MOS transistor 242a and the N-type MOS transistor 242b result in a desired threshold voltage VTH0 on the basis of expressions (1) to (3). The inverter 243 is designed such that, for example, the gate widths and gate lengths of the P-type MOS transistor 242a and the N-type MOS transistor 242b result in a desired threshold voltage VTH0. The effective gate width or gate length may be adjusted by providing at least one of the P-type MOS transistor 242a or the N-type MOS transistor 242b plurally in parallel or in series.

The comparator 241a of the inverter type according to configuration example 1 can be configured with few transistors, and therefore has the features of a small area and low power.

### (2) Configuration Example 2

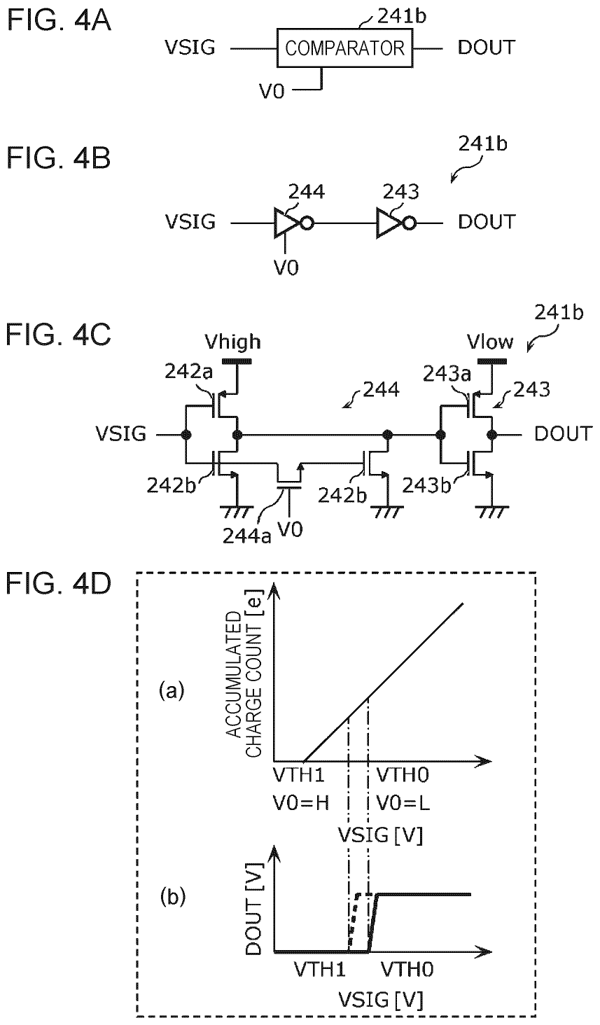

Next, a comparator according to configuration example 2 will be described. FIGS. 4A to 4C are circuit diagrams of a comparator according to configuration example 2. A comparator 241b according to configuration example 2 is illustrated as a function block in FIG. 4A, is illustrated at the symbol level in FIG. 4B, and is illustrated at the transistor level in FIG. 4C. As illustrated in FIGS. 4A to 4C, the comparator 241b is comparator of the variable inverter threshold type. The comparator 241b is formed from two inverters 244 and 243. The comparator 241b has a configuration that is obtained by changing the inverter 242 in the comparator 241a above to the inverter 244, which is configured to have a variable threshold voltage.

In the comparator 241b, the inverter 244 and the inverter 243 are connected in series. The pixel signal VSIG is inputted into the inverter 244, and the output of the inverter 244 is inputted into the inverter 243. Also, a control signal V0 is applied to the inverter 244. In the inverter 244, the threshold voltage is changed by the control signal V0. The inverter 244 includes one P-type MOS transistor 242a, two N-type MOS transistors 242b, and one transistor 244a. The inverter 244 has a configuration that is obtained by adding one N-type MOS transistor 242b and one transistor 244a to the inverter 242 above.

In the inverter 244, the two N-type MOS transistors 242b are connected in parallel to the drain of the P-type MOS transistor 242a. Out of the two N-type MOS transistors 242b, the pixel signal VSIG is applied to the gate of one N-type MOS transistor 242b without going through the transistor 244a, and the pixel signal VSIG is applied to the gate of the other N-type MOS transistor 242b by going through the transistor 244a. The transistor 244a is switched between conducting and non-conducting states by the control signal V0. The control signal VO is outputted from the drive control circuit 205, for example.

FIG. 4D is a diagram illustrating the relationship between the input signal, namely the pixel signal VSIG, and the output signal DOUT of the comparator 241b. In (a) of FIG. 4D, the relationship between the pixel signal VSIG and an accumulated charge count in the charge accumulator 30 is illustrated, and in (b) of FIG. 4D, the relationship between the pixel signal VSIG and the output signal DOUT is illustrated.

In the comparator 241b, the basic relationship between the pixel signal VSIG and the output signal DOUT is the same as in the comparator 241a described using FIG. 3D, but the comparator 241b differs from the comparator 241a in that the control signal V0 can be switched between high and low to change the threshold voltage between a threshold voltage VTH0 and a threshold voltage VTH1. In other words, it is possible to alter the determination level of the comparator 241b by using the control signal V0. As illustrated in FIG. 4D, when the control signal V0 is low, the accumulated charge count in the charge accumulator 30 increases gradually, and once the pixel signal VSIG exceeds the threshold voltage VTH0, the output signal DOUT of the comparator 241b changes from low (for example, a digital value of zero) to high (for example, a digital value of 1). When the control signal V0 is low, the transistor 244a is in the non-conducting state, and therefore the pixel signal VSIG is applied to only one of the two N-type MOS transistors 242b and the threshold voltage VTH0 of the inverter 244 is the same as the inverter 242.

On the other hand, when the control signal V0 is high, the accumulated charge count in the charge accumulator 30 increases gradually, and once the pixel signal VSIG exceeds the threshold voltage VTH1, the output signal DOUT of the comparator 241b changes from low to high. Specifically, when the control signal V0 is high, the transistor 244a is in the conducting state, the pixel signal VSIG is applied to both of the two N-type MOS transistors 242b, which in effect increases the gate width Wₙ of the N-type MOS transistors 242b. As a result, the threshold voltage of the inverter 244 changes from the threshold voltage VTH0 to the threshold voltage VTH1, as can be understood from expressions (1) to (3) above. That is, in the comparator 241b, it is possible to change the threshold voltage to be compared with the pixel signal VSIG when performing AD conversion using the comparator 241b.

Note that in the example illustrated in FIGS. 4A to 4C, two N-type MOS transistors 242b are provided in parallel, but the configuration is not limited thereto. For example, a configuration that allows for changing among three available threshold voltages may be realized by providing three or more N-type MOS transistors 242b in parallel and providing two or more transistors 244a for control. Also, two or more P-type MOS transistors 242a rather than N-type MOS transistors 242b may be provided in parallel. Also, two or more provided N-type MOS transistors 242b or P-type MOS transistors 242a may be connected in series. In this case, the threshold voltage of the inverter 244 is changed by using the control signal VO to change the effective gate length.

### (3) Configuration Example 3

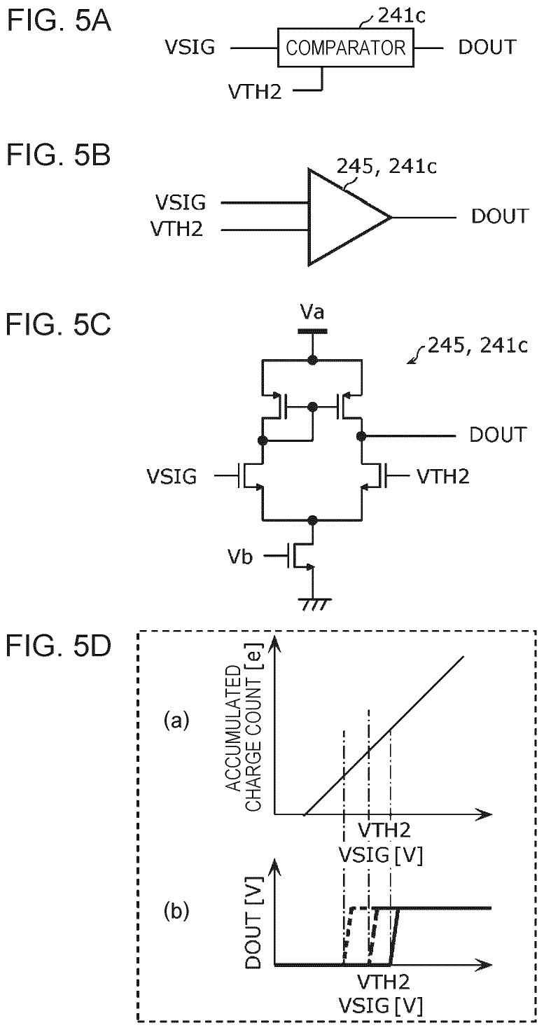

Next, a comparator according to configuration example 3 will be described. FIGS. 5A to 5C are circuit diagrams of a comparator according to configuration example 3. A comparator 241c according to configuration example 3 is illustrated as a function block in FIG. 5A, is illustrated at the symbol level in FIG. 5B, and is illustrated at the transistor level in FIG. 5C. As illustrated in FIGS. 5A to 5C, the comparator 241c is a comparator of the differential amplifier type. The comparator 241c is formed by a differential amplifier 245 into which a reference signal VTH2 with a variable voltage value is inputted. The pixel signal VSIG and the reference signal VTH2 are inputted into two input terminals of the differential amplifier 245. The reference signal VTH2 is outputted from the drive control circuit 205, for example.

FIG. 5D is a diagram illustrating the relationship between the input signal, namely the pixel signal VSIG, and the output signal DOUT of the comparator 241c. In (a) of FIG. 5D, the relationship between the pixel signal VSIG and an accumulated charge count in the charge accumulator 30 is illustrated, and in (b) of FIG. 5D, the relationship between the pixel signal VSIG and the output signal DOUT is illustrated.

As illustrated in FIG. 5D, the accumulated charge count in the charge accumulator 30 increases gradually, and once the pixel signal VSIG exceeds the reference signal VTH2, the output signal DOUT of the comparator 241c changes from low (for example, a digital value of zero) to high (for example, a digital value of 1). In this case, in the comparator 241c, it is possible to alter the determination level of the comparator 241c by varying the reference signal VTH2. When the pixel signal VSIG is equal to or lower than the reference signal VTH2 serving as the threshold, the output signal DOUT goes low, and when the pixel signal VSIG is higher than the reference signal VTH2 serving as the threshold, the output signal DOUT goes high. In this way, by using the comparator 241c, the threshold for determining the pixel signal VSIG can be set flexibly.

### Operation of Imaging Device

Next, the operation of the imaging device 200 according to the present embodiment will be described. The imaging device 200 has a normal mode, a one-time mode, and an add-on mode as operating modes, for example. In the normal mode, the imaging device 200 generates first image data by performing AD conversion using only the first conversion circuit 230 out of the first conversion circuit 230 and the second conversion circuit 240, and outputs an image based on the first image data.

The following describes details of the one-time mode and the add-on mode.

The one-time mode is an operating mode in which a 1-bit mode and a normal bit mode are performed. The add-on mode is an operating mode in which the 1-bit mode is performed but the normal bit mode is not performed. In the 1-bit mode, the second conversion circuit 240 converts the pixel signal VSIG into a second digital signal, and second image data containing the second digital signal is generated. In the normal bit mode, the first conversion circuit 230 converts the pixel signal VSIG into a first digital signal, and first image data containing the first digital signal is generated. Note that in this specification, the “1-bit mode” is not limited to an operating mode for converting the pixel signal VSIG into a 1-bit digital signal, but rather is used as a term that means an operating mode for converting the pixel signal VSIG into a digital signal with a lower resolution than in the normal bit mode. That is, insofar as the resolution of the second digital signal converted in 1-bit mode is fewer than the resolution of the first digital signal, the 1-bit mode is not limited to 1 bit, or in other words 2. Accordingly, the “1-bit mode” may also be referred to as the “few-bit mode”.

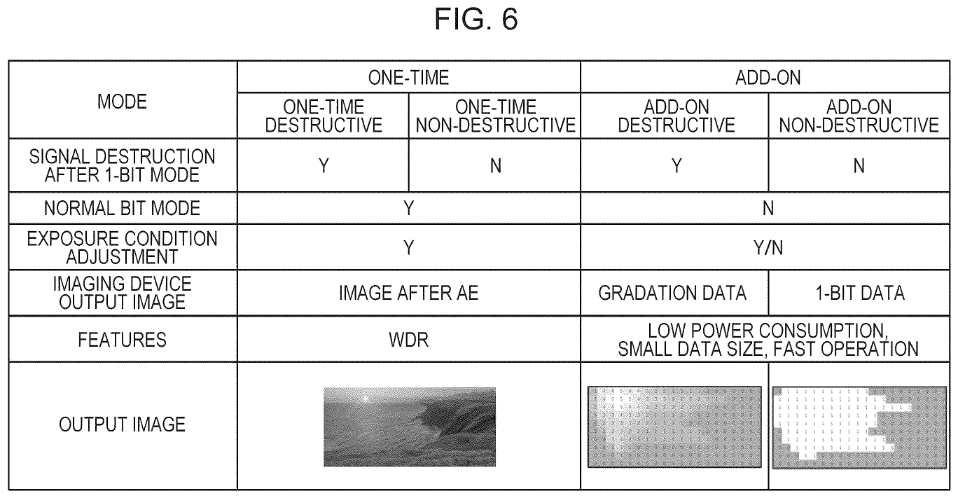

FIG. 6 is a diagram illustrating a mode table summarizing differences between the operating modes of an imaging device according to the present embodiment. Each of the operating modes operates by combining the 1-bit mode with the normal bit mode, as necessary.

The one-time mode, in which both the 1-bit mode and the normal bit mode are performed one time, may achieve wide dynamic range (WDR) through automatic exposure adjustment (AE). The one-time mode is divided into a one-time destructive mode, in which the pixel signal VSIG is destroyed (reset) after signal readout in the 1-bit mode, and a one-time non-destructive mode, in which the pixel signal VSIG is in some cases not destroyed after the signal readout.

In the one-time destructive mode, the control circuit 120 decides exposure conditions for generating first image data in a second period after a first period, on the basis of second image data containing a second digital signal converted by the second conversion circuit 240 from the pixel signal VSIG that corresponds to an amount of the signal charge converted by the photoelectric converter 20 in the first period. For example, the first period is the period during which the imaging device 200 operates in the 1-bit mode, and the second period is the period during which the imaging device 200 operates in the normal bit mode.

In the one-time non-destructive mode, the control circuit 120 repeatedly causes the second conversion circuit 240 to convert the pixel signal VSIG into a second digital signal until the second image data meets a prescribed condition in a period, within one frame period, during which the pixel signal VSIG is not destroyed. Additionally, once the second image data meets the prescribed condition, the control circuit 120 causes the first conversion circuit 230 to convert the pixel signal VSIG into a first digital signal.

The add-on mode, in which an image based on second image data generated in the 1-bit mode is outputted without performing the normal bit mode, may achieve low power consumption, small data size, and fast operation. The add-on mode is divided into an add-on destructive mode, in which the pixel signal VSIG is destroyed (reset) after signal readout in the 1-bit mode, and an add-on non-destructive mode, in which the pixel signal VSIG is in some cases not destroyed after the signal readout.

In the add-on destructive mode, a plurality of second image data is generated under mutually different exposure conditions, and the control circuit 120 outputs merged image data obtained by integrating the plurality of second image data.

In the add-on non-destructive mode, the control circuit 120 repeatedly causes the second conversion circuit 240 to convert the pixel signal VSIG into a second digital signal until the second image data meets a prescribed condition in a period, within one frame period, during which the pixel signal VSIG is not destroyed. The control circuit 120 then outputs second image data that meets the prescribed condition.

Also, in the one-time mode, after performing exposure condition adjustment on the basis of the imaging result in the 1-bit mode, the normal bit mode is also executed, and thus normal image data is outputted, but in the add-on mode, the normal bit mode is not executed, and thus only 1-bit data or data having a prescribed resolution is outputted from the sensor.

Hereinafter, details of each operating mode will be described.

### (1) Operation Example 1 (One-Time Destructive Mode)

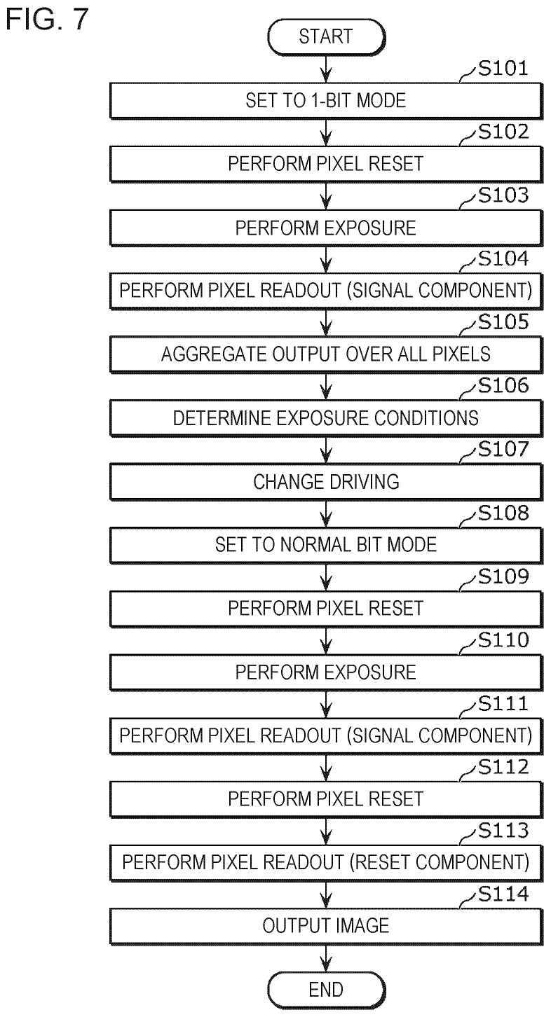

First, the operation in the one-time destructive mode will be described as operation example 1 of the imaging device 200, with reference to FIGS. 7, 8, 9A, and 9B.

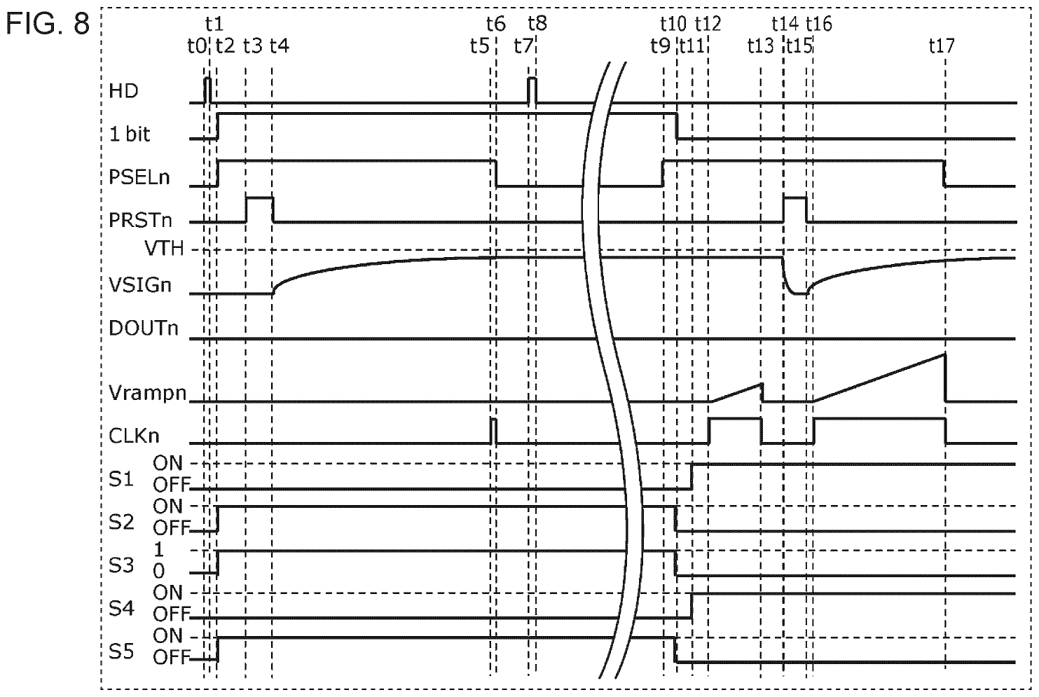

FIG. 7 is a flowchart of operation example 1 of an imaging device according to the present embodiment. FIG. 8 is one example of a timing chart of operation example 1 of an imaging device according to the present embodiment. FIG. 8 illustrates timings within one frame period for outputting an output image, mainly the timing when the pixel 10 in the n-th row in a certain column of the pixel section 201 is selected, and the pixel signal VSIG generated by that pixel 10 is AD-converted.

In “HD” of FIG. 8, the timing of a horizontal synchronization signal HD is indicated, and the imaging in a certain row of the pixel section 201 is started at the timing of a pulse of the horizontal synchronization signal HD.

In “1bit” of FIG. 8, the timing of a 1-bit mode control signal 1bit is indicated, and the imaging device 200 operates in the 1-bit mode when the 1-bit mode control signal 1bit is high. Also, the imaging device 200 operates in the normal bit mode when the 1-bit mode control signal 1bit is low. The 1-bit mode control signal 1bit is supplied to the drive control circuit 205 from the exposure adjustment circuit 123, for example.

In “PSELn” of FIG. 8, the timing of the pixel select signal PSEL for the n-th row is indicated, and when the pixel select signal PSEL is high, the pixel 10 in the n-th row are selected, and the pixel signal VSIG for the n-th row is outputted from the pixel 10 to the conversion circuit 220.

In “PRSTn” of FIG. 8, the timing of the pixel reset signal PRST for the n-th row is indicated, and when the pixel reset signal PRST is high, the pixel signal VSIG for the n-th row is reset to a reset level. Specifically, a reset voltage is supplied to the charge accumulator 30 of the pixel 10 in the n-th row, and the potential of the charge accumulator 30 is reset. That is, the signal charges accumulated in the charge accumulator 30 are destroyed.

In “VSIGn” of FIG. 8, the change in the potential of the pixel signal VSIG for the n-th row is indicated along with the threshold VTH serving as the prescribed threshold of the comparator 241.

In “DOUTn” of FIG. 8, the change in the potential (whether low or high) of the output signal DOUT of the comparator 241 corresponding to the pixel 10 in the n-th row is indicated.

In “Vrampn” of FIG. 8, the change in the potential of the reference signal Vramp supplied to the comparator 231 corresponding to the pixel 10 in the n-th row is indicated.

In “CLKn” of FIG. 8, the timing of the counter clock CLK corresponding to the pixel 10 in the n-th row is indicated, and the counter 222 counts time while the counter clock CLK is high.

In “S1”, “S2”, “S4”, and “S5” of FIG. 8, the on/off timings of the switches S1, S2, S4, and S5 are indicated.

In “S3” of FIG. 8, the change in the select signal S3 supplied to the selector 221 is indicated, and the selector 221 selects and outputs the output of the comparator 231 when the select signal S3 is 0 or selects and outputs the output of the comparator 241 when the select signal S3 is 1.

Hereinafter, the one-time destructive mode will be described with reference to FIGS. 7 and 8.

First, at time t0, the horizontal synchronization signal HD changes from low to high, and imaging in the n-th row of the pixel section 201 is started. At time t1, the horizontal synchronization signal HD changes from high to low.

Next, at time t2, the 1-bit mode control signal 1bit changes from low to high, and the operation of the imaging device 200 is set to the 1-bit mode (step S101). At this point, the pixel select signal PSEL changes from low to high, the pixel 10 in the n-th row is selected, and the pixel signal VSIG of that pixel 10 is outputted to the conversion circuit 220. In addition, the switches S2 and S5 are changed from off to on and the select signal S3 is changed from 0 to 1, thereby forming a 1-bit mode output path whereby the pixel signal VSIG is converted into a second digital signal in the second conversion circuit 240 and outputted to the signal processing circuit 100.

Next, at time t3, the pixel reset signal PRST goes from low to high, resetting the pixel 10 (step S102). For example, the potential of the charge accumulator 30 is reset to the reset voltage, and the pixel signal VSIG goes to a reset level. Subsequently, at time t4, the pixel reset signal PRST goes from high to low, thereby releasing the reset of the pixel 10, and exposure begins (step S103). At the same time as the release of the reset, signal charges corresponding to the amount of light incident on the photoelectric converter 20 begin to accumulate in the charge accumulator 30, and the pixel signal VSIG of the pixel 10 begins to increase with time.

Next, at time t5, which occurs after a prescribed time elapses from the reset release of the pixel 10 at time t4, the counter clock CLK is changed from low to high, and due to this change, the output signal DOUT of the comparator 241 begins to be stored in the counter 222. As a result, the pixel signal VSIG, which includes a signal component originating in the light incident on the photoelectric converter 20, is read out (step S104). In the example illustrated in FIG. 8, the pixel signal VSIG is equal to or lower than the threshold VTH of the comparator 241, and therefore a low output signal DOUT corresponding to a digital value is 0 is stored in the counter 222. Subsequently, at time t6, the counter clock CLK is changed from high to low, and the storage of the output signal DOUT in the counter 222 ends. The output result from the counter 222 is stored in the latch 224 as a second digital signal. In the example illustrated in FIG. 8, a second digital signal with a pixel value of 0 is stored in the latch 224. Also, at time t6, the pixel select signal PSEL is changed from high to low, ending the selection of the pixel in the n-th row.

Next, at time t7, the horizontal synchronization signal HD changes from low to high, and imaging the pixel 10 in the (n+1)-th row of the pixel section 201 is started. At time t8, the horizontal synchronization signal HD changes from high to low. The pixels 10 after the (n+1)-th row likewise are selected sequentially, and all of the plurality of pixels 10 are selected row by row.

The second digital signals stored in the latches 224 of each of the columns are read out sequentially by the horizontal scan circuit 203 and inputted as second image data into the data processing circuit 121 of the signal processing circuit 100. In the second image data, in the case where the second digital signals have a resolution of 2, the pixels 10 that correspond to the high output signal DOUT have a pixel value of 1, and the pixels 10 that correspond to the low output signal DOUT have a pixel value of 0. That is, in the 1-bit mode, the imaging device 200 determines whether the pixel value of each pixel 10 is 0 or 1.

Next, the data processing circuit 121 aggregates the total output of all the pixels 10 in the inputted second image data (step S105). For example, the data processing circuit 121 counts up the total of the pixel values in the second image data (in other words, in the present operation example, the number of pixels 10 with a pixel value of 1).

Next, the exposure adjustment circuit 123 decides exposure conditions for generating first image data on the basis of the aggregation result from the data processing circuit 121 (step S106). The drive control circuit 205 then changes the drive settings for each circuit of the imaging device 200 on the basis of the exposure conditions decided by the exposure adjustment circuit 123 (step S107). The exposure adjustment circuit 123 decides exposure conditions for generating first image data on the basis of the total of the pixel values in the second image data, for example. The exposure adjustment circuit 123 decides exposure conditions such that, for example, the greater the total of the pixel values in the second image data is, the shorter the exposure time or the stronger the electronic ND filter function is. Note that the exposure adjustment circuit 123 may also decide exposure conditions on the basis of a data processing result other than the total of the pixel values in the second image data, such as the manner in which pixels 10 with a pixel value of 1 are distributed in the second image data. Next, at time t9, the pixel select signal PSEL in the n-th row is changed again from high to low.

Next, at time t10, the 1-bit mode control signal 1bit is changed from high to low, the 1-bit mode ends, and the operation of the imaging device 200 is set to the normal bit mode (step S108). At this point, the switches S2 and S5 are changed from on to off and the select signal S3 is changed from 1 to 0, and as a result, the 1-bit mode output path is no longer formed. In addition, at time t11, the switches S1 and S4 are changed from off to on, thereby forming a normal bit mode output path whereby the pixel signal VSIG is converted into a first digital signal in the first conversion circuit 230 and outputted to the signal processing circuit 100. Note that the above steps S104 to S107 need not be completed by time t10, and may simply be completed by the start of exposure (time t15) in the normal bit mode, to be described later.

Next, at time t12, the reference signal generation circuit 204 begins generation of a ramp signal as the reference signal Vramp. Also, at this point, the counter clock CLK goes to high, and the counter 222 starts counting. Subsequently, at time t13, the reference signal generation circuit 204 ends generation of the ramp signal that had been generated as the reference signal Vramp. Also, at this point, the counter clock CLK goes to low, and the counter 222 stops counting.

Next, at time t14, the pixel reset signal PRST goes from low to high, resetting the pixel 10 (step S109). The pixel signal VSIG, which is the input signal into the comparator 231, begins to return to the reset level. Subsequently, at time t15, which occurs after a time for allowing the pixel signal VSIG to return to the reset level elapses from time t14, the pixel reset signal PRST goes from high to low, thereby releasing the reset of the pixel 10, and exposure begins (step S110). At the same time as the release of the reset, signal charges corresponding to the amount of light incident on the photoelectric converter 20 begin to accumulate in the charge accumulator 30, and the pixel signal VSIG of the pixel 10 begins to increase with time. The exposure in step S110 is performed under the exposure conditions decided in step S106. For example, exposure is performed in an exposure period for global shutter driving or rolling shutter driving, or with a voltage applied to the counter electrode 23 in electronic ND driving, as decided in step S106.

Next, at time t16, the reference signal generation circuit 204 begins generation of a ramp signal as the reference signal Vramp. Also, at this point, the counter clock CLK goes to high, and the counter 222 starts counting. Subsequently, at time t17, the reference signal generation circuit 204 ends generation of the ramp signal that was generated as the reference signal Vramp. Also, at this point, the counter clock CLK goes to low, and the counter 222 stops counting. Also, at this point, the pixel select signal PSEL for the n-th row is changed from high to low, ending the selection of the n-th row.

Next, after an exposure time elapses from time t15, the pixel signal VSIG, which includes a signal component originating in light incident on the photoelectric converter 20 in the exposure that began at time t15, is read out (step S111), converted into a first digital signal by the first conversion circuit 230, and stored in the latch 224. The first digital signals stored in the latches 224 of each of the columns are read out sequentially by the horizontal scan circuit 203 and inputted as first image data into the image processing circuit 110 of the signal processing circuit 100. The first image data is stored in the frame memory 130, for example.

After the readout of the pixel signal VSIG that includes a signal component, the pixel 10 is reset (step S112). Subsequently, the pixel signal VSIG, which includes a reset component corresponding to the potential of the charge accumulator 30 after reset, is read out (step S113), and a first digital signal based on the pixel signal VSIG after the reset of each pixel 10 is read out by the horizontal scan circuit 203. The image processing circuit 110 subtracts the first digital signal after reset from the first digital signal before reset, these first digital signals corresponding to each pixel 10, further performs correction processing or the like, as necessary, and outputs image data generated as a result to the outside (step S114). The signal component is based on the amount of signal charges accumulated in the charge accumulator 30 after reset, and therefore includes a component originating in the amount of signal charges accumulated after reset, and a reset component. Accordingly, by subtracting the reset component from the signal component, the influence of the reset component is eliminated, and image data based on the component originating in the amount of signal charges accumulated after reset can be outputted.

Note that in steps S111 to S114, the AD-converted pixel signal VSIG is used to subtract the reset component from the signal component, but the configuration is not limited thereto. The reset component may also be subtracted from the signal component while in the analog signal state by inputting the potential difference of the pixel signal VSIG before and after reset into the comparator 231 and then performing AD conversion. For example, a switch is provided between the capacitor C1 and the comparator 231, and the switch is turned off while the pixel signal VSIG that includes the signal component is being outputted, resulting in a floating state between the switch and the other end of the capacitor C1. With this arrangement, the pixel signal VSIG that includes the signal component is held temporarily, allowing the reset component to be subtracted from the signal component while in the analog signal state.

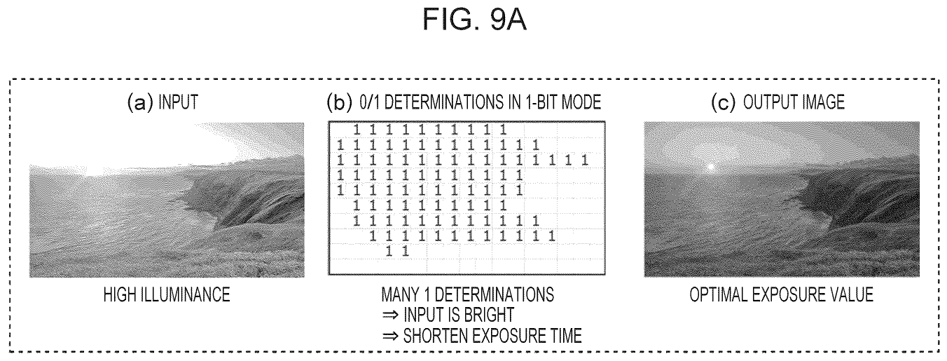

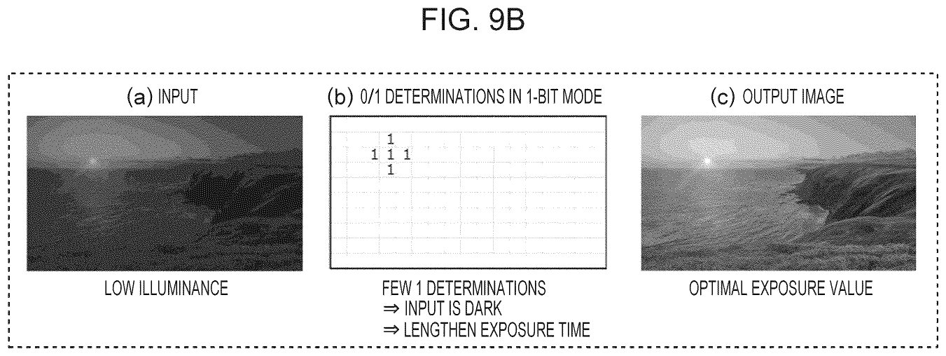

FIGS. 9A and 9B are schematic diagrams for explaining specific examples in operation example 1 of an imaging device according to the present embodiment. FIG. 9A illustrates an example of a case where the inputted image has high illuminance, and FIG. 9B illustrates an example of a case where the inputted image has low illuminance. The image inputted into the imaging device 200 is illustrated in (a) of FIGS. 9A and 9B. The distribution of pixels with a pixel value of 1 (pixel value 0/1 determination results) in the second image data, as aggregated by the data processing circuit 121 in the 1-bit mode, is illustrated in (b) of FIGS. 9A and 9B. The image outputted from the imaging device 200 is illustrated in (c) of FIGS. 9A and 9B.

As illustrated in (a) and (b) of FIG. 9A, when an image of high illuminance is inputted into the imaging device 200, the aggregate value of pixels with a 1 determination by the data processing circuit 121 in the 1-bit mode is larger. Consequently, for example, the image inputted into the imaging device 200 may be determined to be bright in the determination circuit 122. As a result, the exposure adjustment circuit 123 sets a shorter exposure time, for example. The drive control circuit 205 changes the drive settings in accordance with the exposure conditions decided by the exposure adjustment circuit 123. The generation of the first image data in the normal bit mode is performed according to the settings with adjusted exposure conditions, and the generated first image data is subjected to various image processing by the image processing circuit 110 and outputted to the outside of the imaging device 200. Consequently, as illustrated in (c) of FIG. 9A, the output image captured in the one-time destructive mode is an image in which the exposure value of the pixel section 201 has been adjusted optimally.

As illustrated in (a) and (b) of FIG. 9B, when an image of low illuminance is inputted into the imaging device 200, the aggregate value of pixels with a 1 determination by the data processing circuit 121 in the 1-bit mode is smaller. Consequently, the image inputted into the imaging device 200 may be determined to be dark in the determination circuit 122. As a result, the exposure adjustment circuit 123 sets a longer exposure time, for example. The drive control circuit 205 changes the drive settings in accordance with the exposure conditions decided by the exposure adjustment circuit 123. The generation of the first image data is performed according to the settings with adjusted exposure conditions, and the generated first image data is subjected to various image processing by the image processing circuit 110 and outputted to the outside of the imaging device 200. Consequently, as illustrated in (c) of FIG. 9B, the output image captured in the one-time destructive mode is an image in which the exposure value of the pixel section 201 has been adjusted optimally.

### (2) Operation Example 2 (One-Time Non-Destructive Mode)

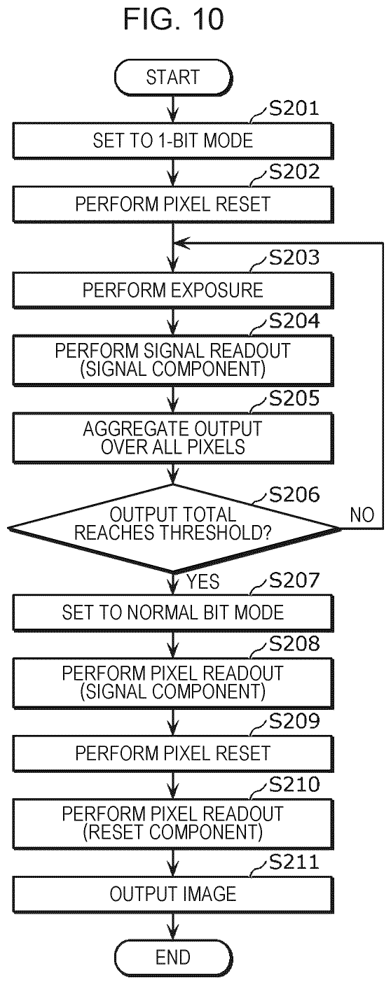

Next, the operation in the one-time non-destructive mode will be described as operation example 2 of the imaging device 200, with reference to FIGS. 10, 11, and 12. Note that in the following description of operation example 2, the description may be omitted or simplified for points in common with operation example 1.

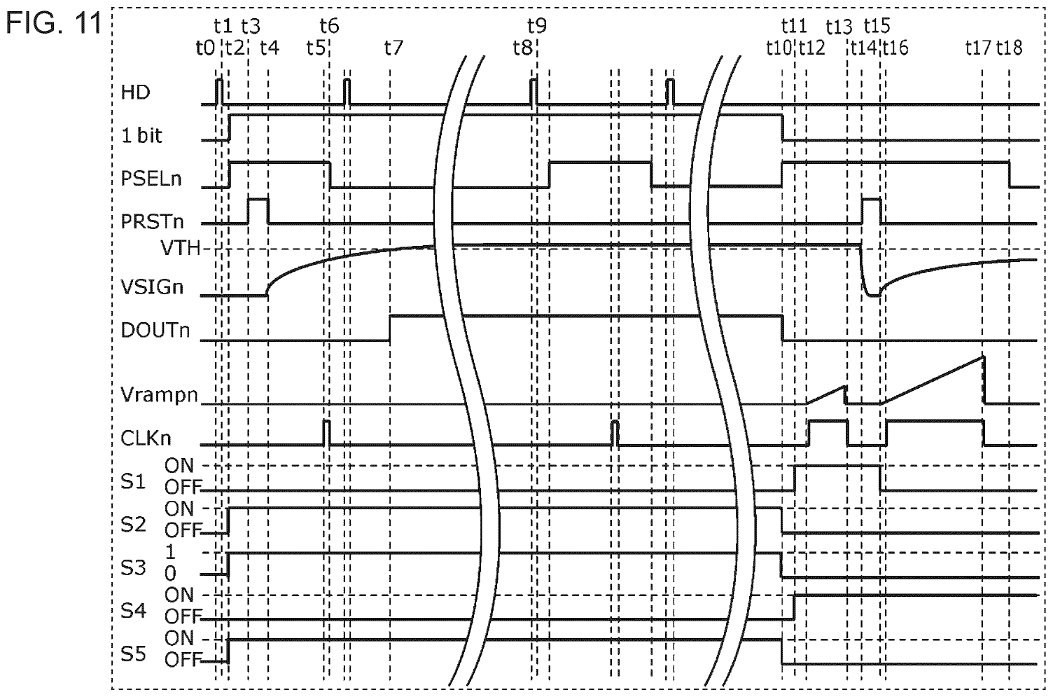

FIG. 10 is a flowchart of operation example 2 of an imaging device according to the present embodiment. FIG. 11 is one example of a timing chart of operation example 2 of an imaging device according to the present embodiment. FIG. 11 illustrates timings within one frame period for outputting an output image, mainly the timing when the pixel 10 in the n-th row in a certain column of the pixel section 201 is selected, and the pixel signal VSIG generated by that pixel 10 is AD-converted. FIG. 11 illustrates the same items as FIG. 8.

Hereinafter, the one-time non-destructive mode will be described with reference to FIGS. 10 and 11.

First, from time t0 to time t6, operations that are similar to the operations from time t0 to time t6 in operation example 1 are performed. That is, the operation of the imaging device 200 is set to the 1-bit mode (step S201), the pixel 10 is reset (step S202), exposure begins (S203), and the pixel signal VSIG that includes a signal component is read out (step S204).

The output result from the counter 222 in the readout of the pixel signal VSIG is stored in the latch 224 as a second digital signal. In the example illustrated in FIG. 11, a second digital signal with a pixel value of 0 is stored in the latch 224. Also, similarly to operation example 1, after time t6, the pixels 10 in the (n+1)-th and subsequent rows are also selected, whereby all of the plurality of pixels 10 are selected row by row, and operations similar to those of the pixel 10 in the n-th row are performed on all of the plurality of pixels 10. The second digital signals stored in the latches 224 of each of the columns are read out sequentially by the horizontal scan circuit 203 and inputted as second image data into the data processing circuit 121 of the signal processing circuit 100.

Next, the data processing circuit 121 aggregates the total output of all the pixels 10 in the inputted second image data (step S205). For example, the data processing circuit 121 counts up the total of the pixel values in the second image data (in other words, in the present operation example, the number of pixels 10 with a pixel value of 1).

Next, the determination circuit 122 determines whether or not the total output has reached a prescribed threshold (step S206). If the determination circuit 122 determines that the total output has not reached the prescribed threshold (step S206, NO), the exposure adjustment circuit 123 decides that the drive control circuit 205 will not change the drive settings, and exposure continues (step S203). The operations from step S203 to step S206 are repeated in the order illustrated in FIG. 10 until the determination circuit 122 determines in step S206 that the output total has reached the prescribed threshold. The interval between readouts of the pixel signal VSIG (step S204) in this repetition may be fixed, but may also vary, such as gradually becoming shorter. FIG. 11 illustrates an example in which exposure continues after time t8, which will be described later.

Next, in the example illustrated in FIG. 11, at time t7, the pixel signal VSIG inputted into the comparator 241 exceeds the threshold VTH of the comparator 241, and thus the output signal DOUT changes from low to high.

At time t8, which occurs after the selection of all of the plurality of pixels 10 that began from time t6 finishes, the horizontal synchronization signal HD changes from low to high, and imaging in the n-th row of the pixel section 201 begins again. At time t9, the horizontal synchronization signal HD changes from high to low. From time t8, the same operations as the operations from time t0 to time t8 are repeated, and accordingly, the operations from step S203 to step S206 are repeated. For this reason, in operation example 2, the second conversion circuit 240 converts the pixel signal VSIG into a second digital signal multiple times in a period, within one frame period, during which the pixel signal VSIG is not destroyed.

Next, if the determination circuit 122 determines that the total output has reached the prescribed threshold (step S206, YES), the exposure adjustment circuit 123 changes the drive settings in the drive control circuit 205 to the normal bit mode (step S207).

Specifically, as illustrated in FIG. 11, at time t10, the 1-bit mode control signal 1bit is changed from high to low, the 1-bit mode ends, and the operation of the imaging device 200 is set to the normal bit mode. At this point, the switches S2 and S5 are changed from on to off and the select signal S3 is changed from 1 to 0, and as a result, the 1-bit mode output path is no longer formed. Accordingly, the output signal DOUT of the comparator 241 corresponding to the pixel 10 in the n-th row changes from high to low. In addition, at time t11, the switches S1 and S4 are changed from off to on, thereby forming the normal bit mode output path.

Next, at time t12, the reference signal generation circuit 204 begins generation of a ramp signal as the reference signal Vramp. Also, at this point, the counter clock CLK goes to high, and the counter 222 starts counting. Subsequently, at time t13, the reference signal generation circuit 204 ends generation of the ramp signal that had been generated as the reference signal Vramp. Also, at this point, the counter clock CLK goes to low, and the counter 222 stops counting. In a period that includes the interval from time t12 to time t13, the pixel signal VSIG, which includes a signal component originating in light incident on the photoelectric converter 20 in the exposure that began at time t4, is read out (step S208), converted into a first digital signal by the first conversion circuit 230, and stored in the latch 224. The first digital signals stored in the latches 224 of each of the columns are read out sequentially by the horizontal scan circuit 203 and inputted as first image data into the image processing circuit 110 of the signal processing circuit 100. The first image data is stored in the frame memory 130, for example.

Next, at time t14, the pixel reset signal PRST goes from low to high, resetting the pixel 10 (step S209). The pixel signal VSIG inputted into the comparator 231 begins to return to the reset level. Subsequently, at time t15, which occurs after a time for allowing the pixel signal VSIG to return to the reset level elapses from time t14, the pixel reset signal PRST goes from high to low, thereby releasing the reset of the pixel 10. Also, at this point, the switch S1 is changed from on to off.

Next, at time t16, the reference signal generation circuit 204 begins generation of a ramp signal as the reference signal Vramp. Also, at this point, the counter clock CLK goes to high, and the counter 222 starts counting. Subsequently, at time t17, the reference signal generation circuit 204 ends generation of the ramp signal that was generated as the reference signal Vramp. Also, at this point, the counter clock CLK goes to low, and the counter 222 stops counting. In this interval from time t15 to time t17, the pixel signal VSIG, which includes a reset component, is read out (step S210), and a first digital signal based on the pixel signal VSIG after the reset of each pixel 10 is read out by the horizontal scan circuit 203. The image processing circuit 110 subtracts the first digital signal after reset from the first digital signal before reset, these first digital signals corresponding to each pixel 10, further performs correction processing or the like, as necessary, and outputs image data generated as a result to the outside (step S211).

At time t18, the pixel select signal PSEL changes from high to low, releasing the selection of the pixel 10.

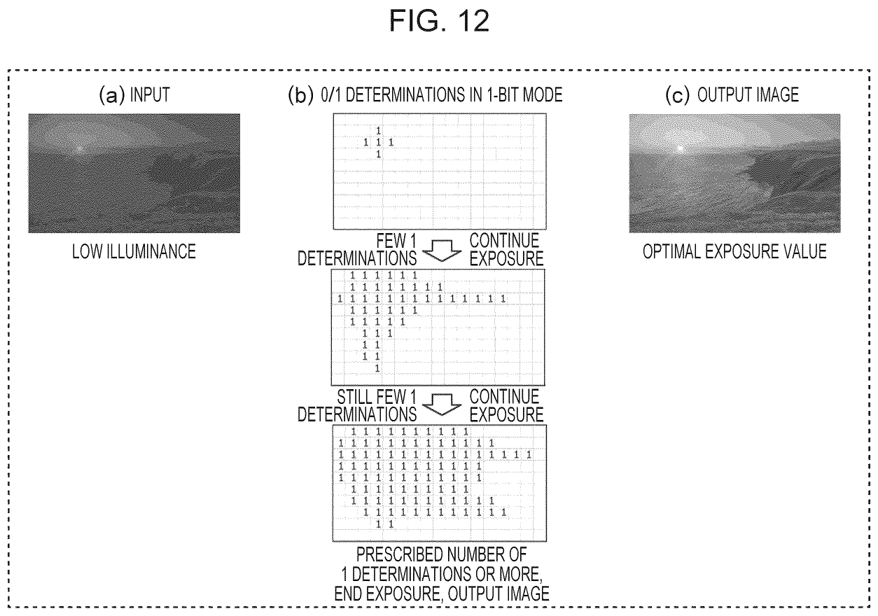

FIG. 12 is a schematic diagram for explaining a specific example in operation example 2 of an imaging device according to the present embodiment. FIG. 12 illustrates an example of a case where the inputted image has relatively low illuminance. The image inputted into the imaging device 200 is illustrated in (a) of FIG. 12. The change in the distribution of pixels with a pixel value of 1 (pixel value 0/1 determination results) in the second image data, as aggregated by the data processing circuit 121 in the 1-bit mode, is illustrated in (b) of FIG. 12. The image outputted from the imaging device 200 is illustrated in (c) of FIG. 12.

As illustrated in (a) and (b) of FIG. 12, when an image of low illuminance is inputted into the imaging device 200, at a point when little time has elapsed since exposure began, the aggregate value of pixels with a 1 determination by the data processing circuit 121 in the 1-bit mode is smaller. Accordingly, exposure is continued. Non-destructive readout of the pixel signal VSIG is repeated without resetting the pixels 10, and once the determination circuit 122 determines that the aggregate value of the pixels with a 1 determination out of all of the pixels in the data processing circuit 121 exceeds a threshold, the exposure adjustment circuit 123 changes the setting from the 1-bit mode to the normal bit mode. Subsequently, the pixel signal VSIG is read out in the normal bit mode to generate first image data, and the generated first image data is subjected to various image processing by the image processing circuit 110 and outputted to the outside of the imaging device 200. Consequently, as illustrated in (c) of FIG. 12, the output image captured in the one-time non-destructive mode is an image in which the exposure value of the pixel section 201 has been adjusted optimally.

### (3) Operation Example 3 (Add-On Destructive Mode)

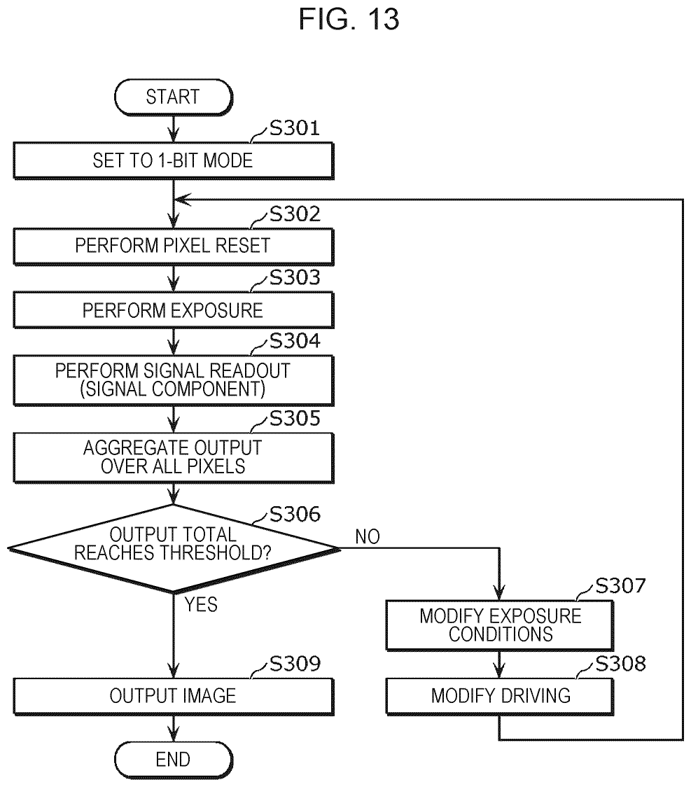

Next, the operation in the add-on destructive mode will be described as operation example 3 of the imaging device 200, with reference to FIGS. 13, 14, and 15. Note that in the following description of operation example 3, the description may be omitted or simplified for points in common with operation examples 1 and 2.

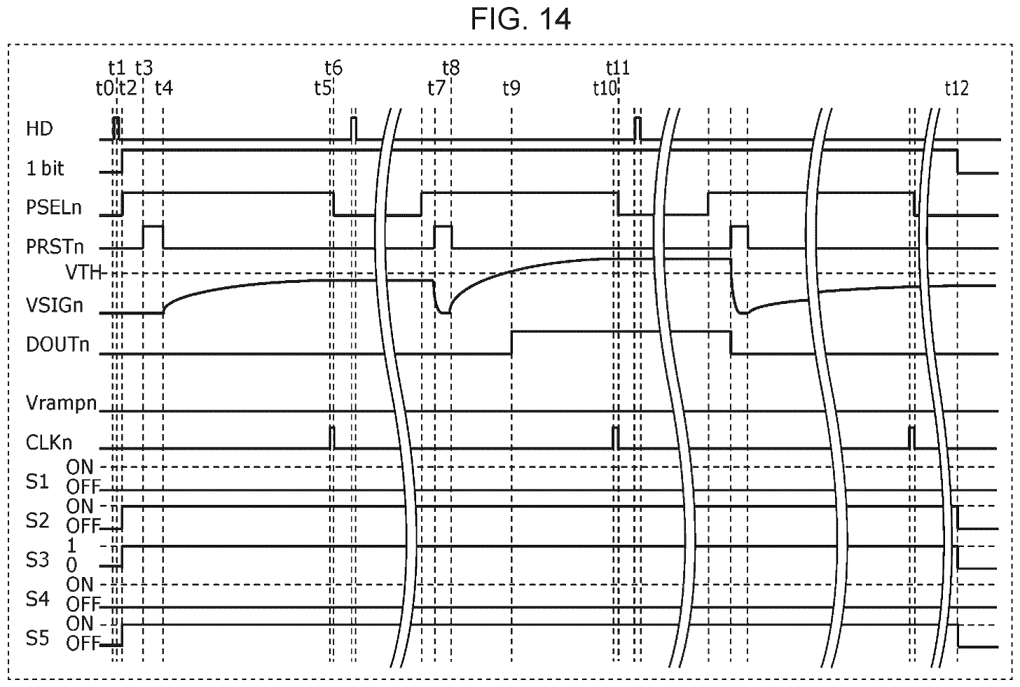

FIG. 13 is a flowchart of operation example 3 of an imaging device according to the present embodiment. FIG. 14 is one example of a timing chart of operation example 3 of an imaging device according to the present embodiment. FIG. 14 illustrates timings within one frame period for outputting an output image, mainly the timing when the pixel 10 in the n-th row in a certain column of the pixel section 201 is selected, and the pixel signal VSIG generated by that pixel 10 is AD-converted. FIG. 14 illustrates the same items as FIG. 8.

Hereinafter, the add-on destructive mode will be described with reference to FIGS. 13 and 14.

First, from time t0 to time t6, operations that are similar to the operations from time t0 to time t6 in operation example 1 are performed. That is, the operation of the imaging device 200 is set to the 1-bit mode (step S301), the pixel 10 is reset (step S302), exposure begins (S303), and the pixel signal VSIG that includes a signal component is read out (step S304).

The output result from the counter 222 in the readout of the pixel signal VSIG is stored in the latch 224 as a second digital signal. In the example illustrated in FIG. 14, a second digital signal with a pixel value of 0 is stored in the latch 224. Also, similarly to operation example 1, after time t6, the pixels 10 in the (n+1)-th and subsequent rows are also selected, whereby all of the plurality of pixels 10 are selected row by row, and operations similar to those of the pixel 10 in the n-th row are performed on all of the plurality of pixels 10. The second digital signals stored in the latches 224 of each of the columns are read out sequentially by the horizontal scan circuit 203 and inputted as second image data into the data processing circuit 121 of the signal processing circuit 100. The second image data is stored in the frame memory 130, for example.

Next, the data processing circuit 121 aggregates the total output of all the pixels 10 in the inputted second image data (step S305). For example, the data processing circuit 121 counts up the total of the pixel values in the second image data (in other words, in the present operation example, the number of pixels 10 with a pixel value of 1).

Next, the determination circuit 122 determines whether or not the total output has reached a prescribed threshold (step S306). If the determination circuit 122 determines that the total output has not reached the prescribed threshold (step S306, NO), the exposure adjustment circuit 123 changes the exposure conditions for generating the second image data (step S307), and the drive control circuit 205 changes the drive settings for each circuit of the imaging device 200 on the basis of the exposure conditions changed by the exposure adjustment circuit 123 (step S308). The operations from step S302 are then performed again. The operations from step S302 to step S308 are repeated in the order illustrated in FIG. 13 until the determination circuit 122 determines in step S306 that the output total has reached the prescribed threshold.

The changed exposure conditions in step S307 may be decided on the basis of the aggregation result from the data processing circuit 121, but may also be decided irrespectively of the aggregation result from the data processing circuit 121. For example, the changed exposure conditions, specifically the exposure time or the sensitivity setting in electronic ND driving, may be random conditions using a random number or the like, and may also be conditions obtained by adding or subtracting a prescribed value to or from the conditions before the change. Note that if exposure has finished, steps S307 and S308 may also be performed before step S306.

FIG. 14 illustrates an example in which the operations from step S302 are performed again from time t6. FIG. 14 also illustrates an example of the case where the sensitivity setting in electronic ND driving is changed. At time t7, the pixel reset signal PRST goes from low to high, resetting the pixel 10 (step S302). The pixel signal VSIG inputted into the comparator 241 begins to return to the reset level. Subsequently, at time t8, which occurs after a time for allowing the pixel signal VSIG to return to the reset level elapses from time t7, the pixel reset signal PRST goes from high to low, thereby releasing the reset of the pixel 10, and exposure begins again (step S303). At the same time as the release of the reset, the pixel signal VSIG begins to increase with time.

Next, in the example illustrated in FIG. 14, at time t9, the pixel signal VSIG inputted into the comparator 241 exceeds the threshold VTH of the comparator 241, and thus the output signal DOUT changes from low to high.

At time t10, which occurs after a prescribed time elapses from time t8, the counter clock CLK is changed from low to high, and due to this change, the output signal DOUT of the comparator 241 begins to be stored in the counter 222. As a result, the pixel signal VSIG, which includes a signal component originating in the light incident on the photoelectric converter 20, is read out again (step S304). In the example illustrated in FIG. 14, a high output signal DOUT, which corresponds to a digital value of 1, is stored in the counter 222. Subsequently, at time t11, the counter clock CLK is changed from high to low, and the storage of the output signal DOUT in the counter 222 ends. The output result from the counter 222 is stored in the latch 224 as a second digital signal. Also, at time t11, the pixel select signal PSEL is changed from high to low, ending the selection of the pixel in the n-th row. Additionally, the pixels 10 in the (n+1)-th and subsequent rows are also selected, whereby all of the plurality of pixels 10 are selected row by row, and operations similar to those of the pixel 10 in the n-th row are performed on all of the plurality of pixels 10. The second digital signals stored in the latches 224 of each of the columns are read out sequentially by the horizontal scan circuit 203 and inputted as new second image data into the data processing circuit 121 of the signal processing circuit 100. The new second image data is stored in the frame memory 130 directly, or is merged with the second image data already stored in the frame memory 130 and stored, for example.

Next, the data processing circuit 121 aggregates the total output of all the pixels 10 in the second image data again (step S305). At this point, in step S305 of the second and subsequent passes, the total output of the new second image data is added to the total output aggregated in step S305 of the preceding pass(es). The operation in step S306 is then performed again. In the example illustrated in FIG. 14, the operations from step S302 to step S308 are repeated from time t0 to time t12.

If the determination circuit 122 determines that the total output has reached the prescribed threshold (step S306, YES), data processing circuit 121 outputs a merged image, which is gradation data obtained by integrating the plurality of second image data stored in the frame memory 130 (step S309). For example, every time new second image data is inputted, the data processing circuit 121 integrates the new second image data into the second image data (or merged image) stored in the frame memory 130, thereby generating a merged image which is then stored in the frame memory 130. A merged image may also be generated after the determination circuit 122 determines that the total output has reached the prescribed threshold, without generating a merged image every time new second image data is inputted.

Also, in the example illustrated in FIG. 14, since the total output aggregated by the data processing circuit 121 exceeds the prescribed threshold, at time t12, the 1-bit mode control signal 1bit is changed from high to low, the switches S2 and S5 are changed from on to off, and the select signal S3 is changed from 1 to 0, ending the 1-bit mode.

Note that in operation example 3, the operations in steps S305 and S306 need not be performed. For example, a plurality of second image data with different exposure conditions may be generated by repeating the operations from step S302 to step S308 other than steps S305 and S306, and a merged image obtained by integrating the generated plurality of second image data may be outputted.

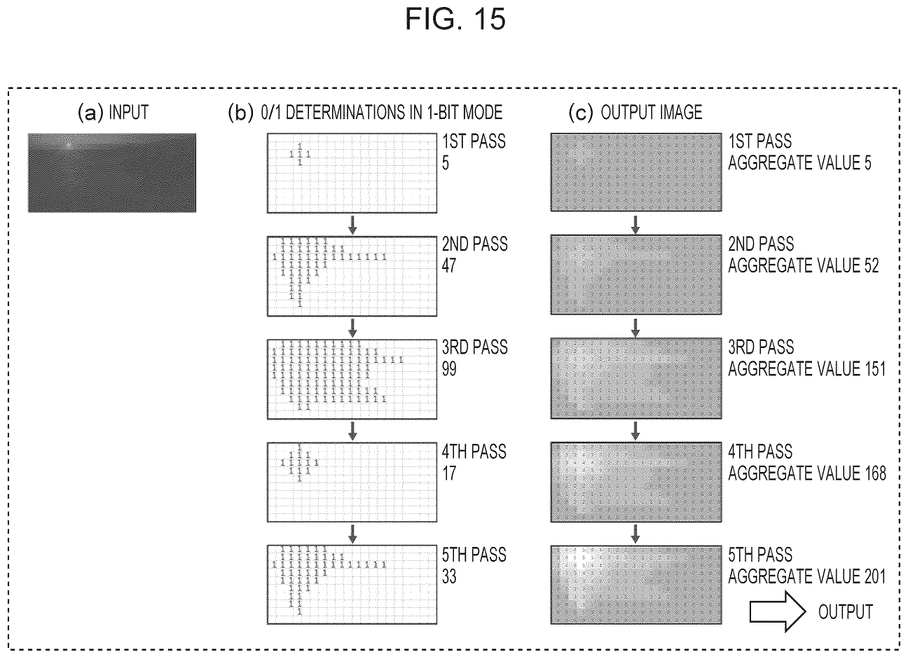

FIG. 15 is a schematic diagram for explaining a specific example in operation example 3 of an imaging device according to the present embodiment. The image inputted into the imaging device 200 is illustrated in (a) of FIG. 15. The change in the distribution of pixels with a pixel value of 1 (pixel value 0/1 determination results) in the second image data inputted into the data processing circuit 121 in the 1-bit mode is illustrated in (b) of FIG. 15. The change in the merged image to be outputted when the total of the pixel values exceeds the threshold is illustrated in (c) of FIG. 15. The data processing circuit 121 aggregates the total of the pixel values in the merged image illustrated in (c) of FIG. 15.

As illustrated in FIG. 15, the generation of second image data in the 1-bit mode is performed repeatedly by changing the exposure conditions with the exposure adjustment circuit 123. Every time second image data is generated, pixels with a 1 determination out of all of the pixels are aggregated in the data processing circuit 121 and added to the aggregate value thus far. This aggregation is repeated until the aggregate value exceeds a threshold. In the example illustrated in FIG. 15, the threshold of the aggregate value is 200, and 200 is exceeded on the fifth pass. When the determination circuit 122 determines that the aggregate value exceeds the threshold, the data processing circuit 121 outputs the merged image, which is gradation data, to the outside of the imaging device 200. In this way, by operating in the add-on destructive mode, the imaging device 200 can easily generate gradation data with a resolution suited to the purpose.

### (4) Operation Example 4 (Add-On Non-Destructive Mode)

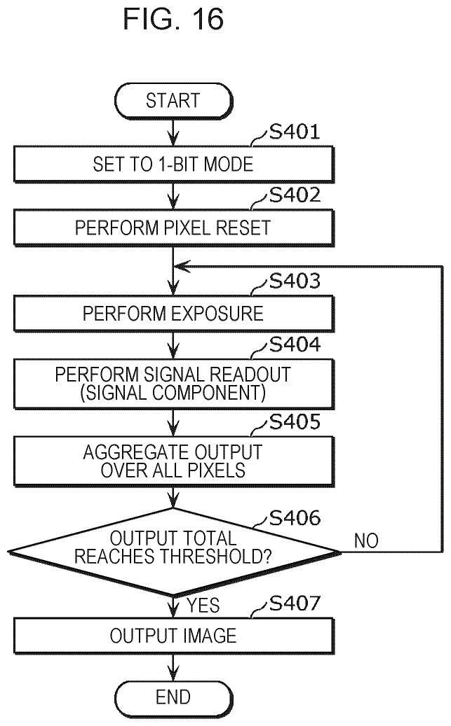

Next, the operation in the add-on non-destructive mode will be described as operation example 4 of the imaging device 200, with reference to FIGS. 16, 17, and 18. Note that in the following description of operation example 4, the description may be omitted or simplified for points in common with operation examples 1 to 3.

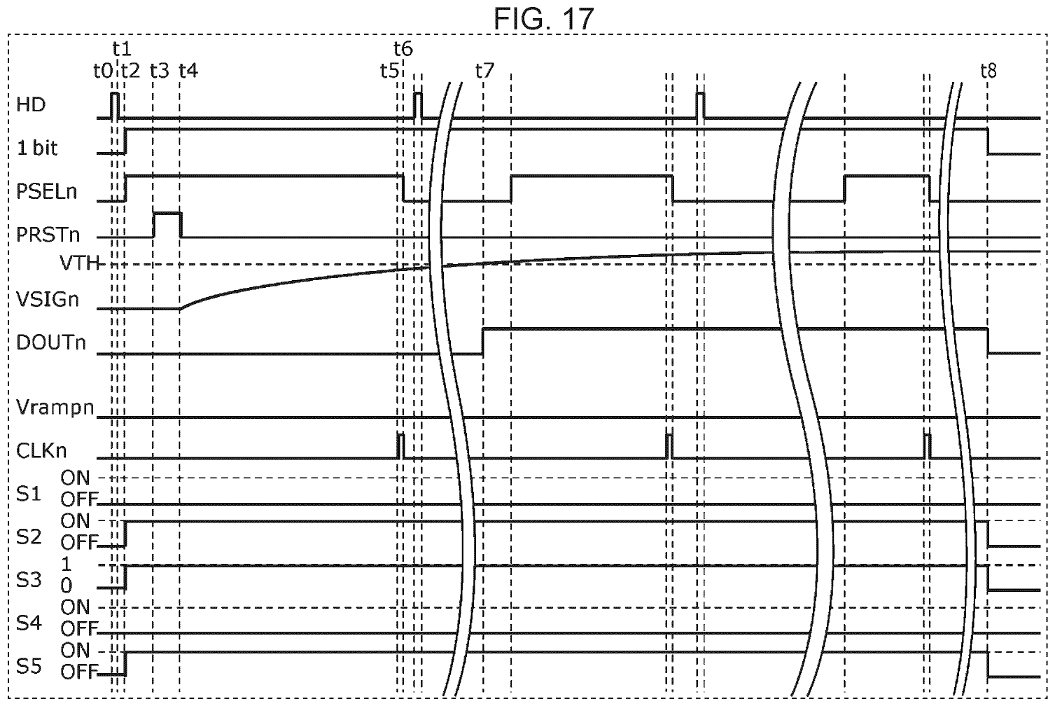

FIG. 16 is a flowchart of operation example 4 of an imaging device according to the present embodiment. FIG. 17 is one example of a timing chart of operation example 4 of an imaging device according to the present embodiment. FIG. 17 illustrates timings within one frame period for outputting an output image, mainly the timing when the pixel 10 in the n-th row in a certain column of the pixel section 201 is selected, and the pixel signal VSIG generated by that pixel 10 is AD-converted. FIG. 17 illustrates the same items as FIG. 8.

Hereinafter, the add-on non-destructive mode will be described with reference to FIGS. 16 and 17.

First, from time t0 to time t6, operations that are similar to the operations from time t0 to time t6 in operation example 1 are performed. That is, the operation of the imaging device 200 is set to the 1-bit mode (step S401), the pixel 10 is reset (step S402), exposure begins (S403), and the pixel signal VSIG that includes a signal component is read out (step S404).

The output result from the counter 222 in the readout of the pixel signal VSIG is stored in the latch 224 as a second digital signal. In the example illustrated in FIG. 17, a second digital signal with a pixel value of 0 is stored in the latch 224. Also, similarly to operation example 1, after time t6, the pixels 10 in the (n+1)-th and subsequent rows are also selected, whereby all of the plurality of pixels 10 are selected row by row, and operations similar to those of the pixel 10 in the n-th row are performed on all of the plurality of pixels 10. The second digital signals stored in the latches 224 of each of the columns are read out sequentially by the horizontal scan circuit 203 and inputted as second image data into the data processing circuit 121 of the signal processing circuit 100. The second image data is stored in the frame memory 130, for example.

Next, the data processing circuit 121 aggregates the total output of all the pixels 10 in the inputted second image data (step S405). For example, the data processing circuit 121 counts up the total of the pixel values in the second image data (in other words, in the present operation example, the number of pixels 10 with a pixel value of 1).

Next, the determination circuit 122 determines whether or not the total output has reached a prescribed threshold (step S406). If the determination circuit 122 determines that the total output has not reached the prescribed threshold (step S406, NO), the exposure adjustment circuit 123 decides that the drive control circuit 205 will not change the drive settings, and exposure continues (step S403). The operations from step S403 to step S406 are repeated in the order illustrated in FIG. 16 until the determination circuit 122 determines in step S406 that the output total has reached the prescribed threshold. This is similar to operation example 2. In the example illustrated in FIG. 17, the operations from step S403 to step S406 are repeated from time t0 to time t8. The interval between readouts of the pixel signal VSIG (step S404) in this repetition may be fixed, but may also vary, such as gradually becoming shorter.

Also, in the example illustrated in FIG. 17, at time t7, the pixel signal VSIG inputted into the comparator 241 exceeds the threshold VTH of the comparator 241, and thus the output signal DOUT changes from low to high.

If the determination circuit 122 determines that the total output has reached the prescribed threshold (step S406, YES), data processing circuit 121 outputs second image data, which is the inputted 1-bit data, as an output image (step S407).

Also, in the example illustrated in FIG. 17, since the total output aggregated by the data processing circuit 121 exceeds the prescribed threshold, at time t8, the 1-bit mode control signal 1bit is changed from high to low, the switches S2 and S5 are changed from on to off, and the select signal S3 is changed from 1 to 0, ending the 1-bit mode. Accordingly, the output signal DOUT of the comparator 241 corresponding to the pixel 10 in the n-th row changes from high to low.

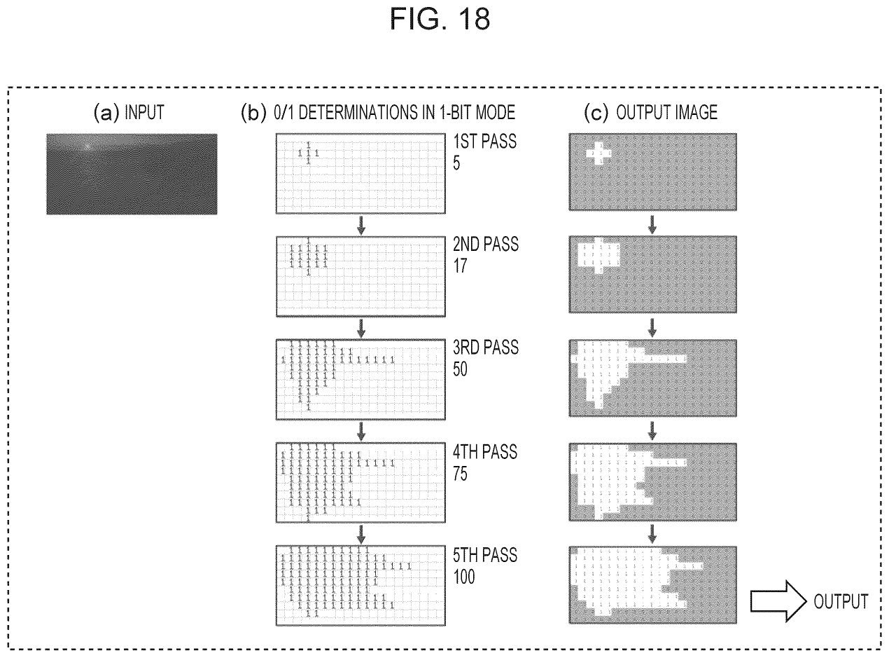

FIG. 18 is a schematic diagram for explaining a specific example in operation example 4 of an imaging device according to the present embodiment. The image inputted into the imaging device 200 is illustrated in (a) of FIG. 18. The change in the distribution of pixels with a pixel value of 1 (pixel value 0/1 determination results) in the second image data, as aggregated by the data processing circuit 121 in the 1-bit mode, is illustrated in (b) of FIG. 18. The change in the output image to be outputted when the total of the pixel values exceeds the threshold is illustrated in (c) of FIG. 18.

As illustrated in FIG. 18, by repeatedly and non-destructively reading out the pixel signal VSIG in the 1-bit mode, the number of pixels whose pixel value goes from 0 to 1 (pixels with a 1 determination) successively increases in the first, second, and third passes, such that by the fifth pass, the total number of pixels with a pixel value of 1 exceeds the threshold of 100. When the determination circuit 122 determines that the total of the pixel values exceeds the threshold, the data processing circuit 121 outputs the output image, which is 1-bit data, to the outside of the imaging device 200. This allows the imaging device 200 to, for example, output 1-bit data, which can be used for boundary separation or the like to determine which portions of the inputted image are bright, with low power consumption, small data size, and fast operation. Such 1-bit data can also be utilized as data for sensing or machine learning.

### Embodiment 2

Next, embodiment 2 will be described. In embodiment 2, a camera system provided with the imaging device 200 according to embodiment 1 is described.

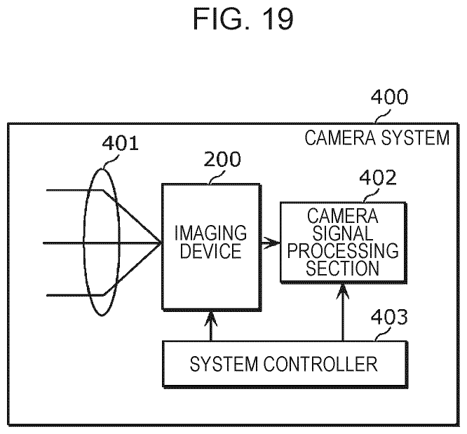

FIG. 19 is a block diagram illustrating one example of the configuration of a camera system 400 according to the present embodiment.

As illustrated in FIG. 19, the camera system 400 according to the present embodiment is provided with the imaging device 200 according to embodiment 1 above, an optical system 401 such as a lens for condensing light, a camera signal processing section 402 for performing signal processing on, and outputting, data captured by the imaging device 200, and a system controller 403 for controlling the imaging device 200 and the camera signal processing section 402.

The optical system 401 is a lens or the like for condensing light onto an imaging area of the imaging device 200.

The camera signal processing section 402 functions as a signal processing circuit that processes output signals from the imaging device 200. The camera signal processing section 402 performs processing such as gamma correction, color interpolation processing, spatial interpolation processing, auto white balance, distance measurement computation, and wavelength information separation, for example. The camera signal processing section 402 is realized by a digital signal processor (DSP), for example.

The system controller 403 controls the overall camera system 400. The system controller 403 may be realized by a microcontroller or the like including one or more processors and a memory, for example.

### Other Embodiments

The foregoing describes an imaging device and a camera system according to the present disclosure on the basis of embodiments, but the present disclosure is not limited to the above embodiments.

For example, in the embodiments above, the photoelectric converter 20 is a multilayer photoelectric conversion element including the photoelectric conversion layer 21, the pixel electrode 22, and the counter electrode 23, but is not limited thereto. The type of photoelectric converter provided in the imaging device 200 is not particularly limited, and the photoelectric converter may also be, for example, a photodiode (PD) or a single-photon avalanche diode (SPAD) embedded in a semiconductor substrate.

Also, in the embodiments above, the conversion circuit 220 includes the first conversion circuit 230 and the second conversion circuit 240, but is not limited thereto. The conversion circuit 220 may also include only the second conversion circuit 240 out of the first conversion circuit 230 and the second conversion circuit 240.

Also, the embodiments above describe an example in which the second conversion circuit 240 converts the pixel signal VSIG into a second digital signal with a resolution of 2. The second digital signal may also have a resolution of 3 or more. In this case, for example, the second conversion circuit 240 includes a plurality of comparators 241 with mutually different thresholds, and the plurality of comparators 241 are connected in parallel. Also, in this case, the second conversion circuit 240 is configured such that the outputs from the plurality of comparators 241 are inputted into the latch 224 without going through the counter 222, and the counter 222 is disposed between the comparator 231 and the selector 221. The resolution of the second digital signal is equal to the number of comparators 241 plus 1, for example. The threshold of each comparator 241 is adjustable, as described in configuration examples 1 to 3 of the comparator 241. Also, in the case where the second conversion circuit 240 is provided with a comparator 241 configured to have a variable threshold, like the comparator 241b according to configuration example 2 or the comparator 241c according to configuration example 3, the pixel signal VSIG may be converted into a second digital signal with a resolution of 3 or more by changing the threshold over time and having the counter 222 count the time until the output signal DOUT changes from low to high.

Also, in the embodiments above, second image data containing second digital signals converted from the pixel signals VSIG outputted from all pixels 10 of the pixel section 201 is generated, but the configuration is not limited thereto. For example, second digital signals converted from the pixel signals VSIG outputted from only some of the pixels 10 from among all pixels 10 of the pixel section 201 may be generated. For example, the pixels 10 that are to output the pixel signals VSIG for conversion into second digital signals may be selected at spaced intervals of a predetermined number of rows and/or columns. This allows for faster generation of second image data.

Also, the imaging device 200 need not be provided with all of the structural elements described in the embodiments above, and may also be configured using only the structural elements for achieving operation according to a certain purpose. Also, in the operation examples above, some operations may not be performed by the imaging device 200.

In the embodiments above, a process executed by a specific processing unit, such as a signal processing circuit, may also be executed by a different processing unit. Also, the order of the multiple processes may be modified, and multiple processes may also be executed in parallel.

General or specific aspects of the present disclosure may be implemented as a system, a device, a method, an integrated circuit, a computer program, or a computer-readable recording medium such as CD-ROM, or any selective combination thereof.

For example, the present disclosure may be implemented as an imaging device according to the embodiments above, as a processing circuit for an imaging device, the processing circuit having the functions of the signal processing circuit according to the embodiments above, as a signal processing method of an imaging device, the signal processing method being performed by the signal processing circuit according to the embodiments above, as a program for causing a computer to execute such a signal processing method, or as a non-transitory computer-readable recording medium on which such a program is recorded.

Otherwise, different aspects constructed by applying various modifications that may occur to a person skilled in the art to the embodiments and examples, or by combining some of the structural elements in the embodiments and examples, are also included in the scope of the present disclosure, insofar as such aspects do not depart from the gist of the present disclosure.

The imaging device and the like according to the present disclosure is usable in any of various types of camera systems and sensor systems, such as digital still cameras, broadcast cameras, professional cameras, medical cameras, monitoring cameras, in-vehicle cameras, digital single-lens reflex (DSLR) cameras, and digital mirrorless single-lens cameras.

What is claimed is:

1. An imaging device comprising:
a plurality of pixels, each pixel including a photoelectric converter that converts light into a signal charge and a charge accumulator that accumulates the signal charge, and each pixel outputting a signal corresponding to an amount of the signal charge accumulated in the charge accumulator;
a first conversion circuit configured to convert the signal into a first digital signal; and
a second conversion circuit configured to convert the signal into a second digital signal, a resolution of the second digital signal being less than a resolution of the first digital signal, wherein
the imaging device generates first image data containing the first digital signal and second image data containing the second digital signal.

2. The imaging device according to claim 1, wherein the first conversion circuit converts the signal read out non-destructively into the second digital signal.

3. The imaging device according to claim 1, wherein the second conversion circuit includes an inverter circuit.

4. The imaging device according to claim 3, wherein the inverter circuit includes an inverter with a variable threshold voltage.

5. The imaging device according to claim 1, wherein the second conversion circuit includes a differential amplifier.

6. The imaging device according to claim 1, wherein the first conversion circuit and the second conversion circuit include a shared counter.

7. The imaging device according to claim 1, wherein the first conversion circuit and the second conversion circuit include a shared latch.

8. The imaging device according to claim 1, wherein
the first conversion circuit includes a comparator that compares the signal with a reference signal, and
the second conversion circuit does not include a comparator that uses the reference signal.

9. The imaging device according to claim 1, further comprising:
a signal processing circuit to which the first image data and the second image data are input.

10. The imaging device according to claim 9, wherein the signal processing circuit includes a frame memory that holds the second image data.

11. The imaging device according to claim 9, wherein
the imaging device generates a plurality of the second image data under mutually different imaging conditions, and
the signal processing circuit outputs a merged image obtained by integrating the plurality of second image data.

12. The imaging device according to claim 1, wherein the second conversion circuit converts the signal into the second digital signal multiple times in a period, within one frame period, during which the signal is not destroyed.

13. The imaging device according to claim 1, further comprising:
a control circuit, wherein
the control circuit adjusts imaging conditions based on the second image data.

14. The imaging device according to claim 13, wherein the control circuit determines imaging conditions for generating the first image data in a second period after a first period, based on the second image data containing the second digital signal converted by the second conversion circuit from the signal corresponding to the amount of the signal charge converted by the photoelectric converter in the first period.

15. The imaging device according to claim 1, further comprising:
a control circuit, wherein
the control circuit performs the following in a period, within one frame period, during which the signal is not destroyed:
the control circuit repeatedly causes the second conversion circuit to convert the signal into the second digital signal until the second image data meets a prescribed condition; and
once the second image data meets the prescribed condition, the control circuit causes the first conversion circuit to convert the signal into the first digital signal.

16. The imaging device according to claim 1, further comprising:
a control circuit, wherein
the control circuit performs the following in a period, within one frame period, during which the signal is not destroyed:
the control circuit repeatedly causes the second conversion circuit to convert the signal into the second digital signal until the second image data meets a prescribed condition; and
the control circuit outputs the second image data that meets the prescribed condition.

17. The imaging device according to claim 1, wherein the resolution of the second digital signal is 4 or less.

18. The imaging device according to claim 17, wherein the resolution of the second digital signal is 2.

19. The imaging device according to claim 1, further comprising:
a signal line to which the signal is input, wherein
the first conversion circuit and the second conversion circuit are connected to the signal line in parallel.

20. An imaging device comprising:
a plurality of pixels, each pixel including a photoelectric converter that converts light into a signal charge, and each pixel outputting a signal corresponding to an amount of the signal charge; and
a conversion circuit configured to convert the signal into a digital signal, a resolution of the digital signal being 2, wherein
the imaging device generates image data containing the digital signal.
